(19) United States
(12) Patent Application Publication
(10) Pub. No.: US 2010/0243446 A1
(43) Pub. Date: Sep. 30, 2010

(54) GAS CONCENTRATION DETECTING SYSTEM AND GAS SENSING DEVICE HAVING THE SYSTEM

(75) Inventors: Keigo MIZUTANI, Okazaki-shi (JP); Hirofumi Noda, Kariya-shi (JP); Takashi Sawada, Chiryu-shi (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/731,603

(22) Filed: Mar. 25, 2010

(30) Foreign Application Priority Data
Mar. 26, 2009 (JP) 2009-075498
Dec. 9, 2009 (JP) 2009-279128

(51) Int. Cl. G01N 27/26

(52) U.S. Cl. 204/427; 204/431

(57) ABSTRACT

A gas concentration detecting system has a first cell generating electric current at first oxygen sensitivity, a second cell generating current at second oxygen sensitivity and a reference cell generating current at reference oxygen sensitivity. The cells have the same structure except that the second cell has a catalyst layer for removing hydrogen as from measured gas containing oxygen gas. The system determines first corrected current from current of the first cell exposed to measured gas, current of the first cell exposed to inspection gas containing oxygen gas at reference concentration and reference cell current of the reference cell exposed to inspection gas, determines second corrected current from current of the second cell exposed to measured gas, current of the second cell exposed to inspection gas and the reference cell current, and detects concentration of hydrogen gas in measured gas from the corrected currents.

### CROSS-REFERENCE TO RELATED APPLICATION

This application is based upon and claims the benefit of priority of the prior Japanese Patent Application 2009-75498 filed on Mar. 26, 2009 and the prior Japanese Patent Application 2009-279128 filed on Dec. 9, 2009, so that the contents of which are incorporated herein by reference.

### BACKGROUND OF THE INVENTION

1. Field of the Invention

The present invention relates to a system for detecting the concentration of specific gas such as hydrogen gas contained in measured gas such as exhaust gas of an internal combustion engine, and relates to a gas sensing device having the system.

2. Description of Related Art

A hydrogen gas sensor for detecting the hydrogen gas concentration has been used for an exhaust system of an internal combustion engine of a vehicle or the like. For example, Published Japanese Patent First Publication No. 2007-155605 discloses a gas sensor for detecting the concentration of hydrogen gas contained in exhaust gas of the engine.

This gas sensor has a solid electrolyte body having oxygen ion conductivity, a first measuring electrode and a second measuring electrode located on the first surface of the solid electrolyte body, a first atmosphere electrode and a second atmosphere electrode located on the second surface of the solid electrolyte body opposite to the first surface so as to be exposed to an atmosphere chamber communicated with the atmosphere, a first diffusion resistance layer located on the first surface of the solid electrolyte body so as to cover the first measuring electrode, a second diffusion resistance layer located on the first surface of the solid electrolyte body so as to cover the second measuring electrode and to be exposed to exhaust gas, and a catalyst layer covering the first diffusion resistance layer and being exposed to the exhaust gas. A first cell is composed of the electrolyte body, the first measuring electrode, the first atmosphere electrode, the first diffusion resistance layer and the catalyst layer. A second cell is composed of the electrolyte body, the second measuring electrode, the second atmosphere electrode and the second diffusion resistance layer. A predetermined electric potential difference is set between the electrodes in each of the cells. The exhaust gas contains hydrogen gas, reducing gas (e.g., CO and HC) and oxidizing gas (O₂ and NOx)

In the first cell, hydrogen gas contained in the exhaust gas is reacted with a portion of oxygen gas in the catalyst layer, the exhaust gas containing the oxygen gas not reacted is diffused into the diffusion resistance layer, and the reducing gas and the oxygen gas in the exhaust gas are reacted with each other on the measuring electrode. When the air-fuel ratio (A/F ratio) of the exhaust gas is placed on the rich side, the concentration of oxygen gas in the exhaust gas is low. Therefore, oxygen ions are pumped in the measuring electrode from the atmosphere electrode through the electrolyte body to be reacted with the reducing gas. When the A/F ratio is placed on the lean side, the concentration of oxygen gas in the exhaust gas is high. Therefore, oxygen ions not reacted with the reducing gas are pumped out from the measuring electrode to the atmosphere electrode through the electrolyte body. Therefore, a first current S1 flowing between the electrodes is generated. This first current I1 depends on the oxygen gas concentration in the exhaust gas reaching the measuring electrode.

In contrast, in the second cell, the exhaust gas containing the oxygen gas and the hydrogen gas is diffused into the diffusion resistance layer, and the reducing gas and the oxygen gas in the exhaust gas are reacted with each other on the measuring electrode while oxygen ions are pumped in or out from the measuring electrode so as to generate a second current I2 flowing between the electrodes. This second current I2 depends on the oxygen gas concentration and the hydrogen gas concentration in the exhaust gas reaching the measuring electrode.

In the diffusion of the exhaust gas into the diffusion resistance layer, the oxygen gas in the exhaust gas is diffused at a concentration gradient and a diffusion speed in the first cell, and each of the oxygen gas and the hydrogen gas in the exhaust gas is diffused at a concentration gradient and a diffusion speed in the second cell. The concentration gradient and the diffusion speed depend on the diffusion resistance of the diffusion resistance layer. The diffusion resistance of the diffusion resistance layer depends on the size of the diffusion resistance layer. Assuming that the size of the resistance layer in the first cell is the same as the size of the resistance layer in the second cell, the relation between the dependency of the current I1 on the oxygen gas concentration in the first cell and the dependency of the current I2 on the oxygen gas concentration in the second cell is fixed. Therefore, the gas sensor can detect the hydrogen gas concentration in the exhaust gas from the difference I2-I1 between the first and second currents.

Because the oxygen gas concentration and the hydrogen gas concentration on the measuring electrode are differentiated from the oxygen gas concentration and the hydrogen gas concentration in the exhaust gas existing around the gas sensor according to the diffusion resistance of the diffusion resistance layer, the diffusion resistance influences the reactivity of oxygen gas (i.e., the sensitivity to oxygen gas) on the measuring electrode and the reactivity of hydrogen gas (i.e., the sensitivity to hydrogen gas) on the measuring electrode.

However, because the gas sensor is manufactured at a predetermined dimensional tolerance or a permissible dimensional deviation, it is difficult to produce the first and second diffusion resistance layers at the same size. As a result, the diffusion resistance of the first diffusion resistance layer is inevitably differentiated from the diffusion resistance of the second diffusion resistance layer. In this case, although the reactivity of hydrogen gas contained in the exhaust gas and the reactivity of oxygen gas contained in the exhaust gas originally have a dependency on the oxygen gas concentration in the exhaust gas, the dependency of the oxygen gas reactivity on the oxygen gas concentration in the first cell is differentiated from the dependency of the oxygen gas reactivity on the oxygen gas concentration in the second cell. Therefore, an error in the detected hydrogen gas concentration is considerably caused due to the difference in the oxygen gas reactivity between the first and second cells. That is, this error depends on the oxygen gas concentration in the measured gas. As a result, the conventional gas sensor cannot detect the hydrogen gas concentration with high precision.

FIG. 1 shows a graph indicating the relation between the hydrogen gas concentration in the exhaust gas and the current difference I2−I1 calculated according to the prior art. Twelve samples of the exhaust gas are prepared. In each sample, the oxygen gas concentration is set at 5%, 10% or 20%, and the hydrogen gas concentration is set at 0%, 1%, 2% or 3%. Samples having the oxygen gas concentration of 5% are indicated by the symbol d, samples having the oxygen gas concentration of 10% are indicated by the symbol □, and samples having the oxygen gas concentration of 20% are indicated by the symbol ◯.

As shown in FIG. 1, the relation between the hydrogen gas concentration and the current difference I2−I1 depends the oxygen gas concentration. In other words, the current difference I2−I1 in the samples set at the same hydrogen gas concentration is changed with the oxygen gas concentration. Therefore, it will be realized that the current difference I2−I1 has a dependency on the oxygen gas concentration.

Further, it is desired that a gas sensor such as an A/F sensor, a NOx sensor or an oxygen sensor is used with a gas sensing element which can detect the hydrogen gas concentration with high precision. The A/F sensor is used to detect the A/F ratio (i.e., air concentration) of the exhaust gas. The NOx sensor is used to detect the concentration of air pollutants such as NOx and to examine the deterioration of the three-way catalyst packed in an exhaust pipe of the exhaust system. The oxygen sensor is used to detect the oxygen gas concentration of the exhaust gas.

### SUMMARY OF THE INVENTION

An object of the present invention is to provide, with due consideration to the drawbacks of the conventional hydrogen gas sensor, a gas concentration detecting system, having a plurality of cells of a gas sensor, which detects the concentration of specific gas such as hydrogen gas, contained in measured gas such as exhaust gas, from currents flowing in the cells with high precision, regardless of the difference in diffusion resistance (i.e., sensitivity to oxygen gas) between the cells.

Further, the object of the present invention is to provide a gas sensing device wherein a gas sensor is used with the gas concentration detecting system for detecting the concentration of the specific gas contained in the measured gas with high precision, regardless of the difference in diffusion resistance (i.e., sensitivity to oxygen gas) between cells of the gas sensor.

According to the first aspect of this invention, the object is achieved by the provision of a gas concentration detecting system, comprising a first cell having a first sensitivity to oxygen gas, a second cell having a second sensitivity to oxygen gas, a reference cell having a reference sensitivity to oxygen gas and a gas concentration detecting unit. The first cell generates a first output electric current, which has a dependency on the first oxygen sensitivity, the concentration of oxygen gas contained in measured gas and the concentration of specific gas contained in the measured gas, when the first cell is placed into the measured gas. The first cell generates a first reference electric current, having a dependency on the first oxygen sensitivity, when the first cell is placed into inspection gas containing oxygen gas at a reference concentration. The second cell generates a second output electric current, having a dependency on the second oxygen sensitivity and the concentration of oxygen gas remaining in the measured gas, while removing the specific gas from the measured gas when the second cell is placed into the measured gas. The second cell generates a second reference electric current, having a dependency on the second oxygen sensitivity, when the second cell is placed into the inspection gas. The reference cell generates a reference cell electric current, having a dependency on the reference oxygen sensitivity, when the reference cell is placed into the inspection gas. The gas concentration detecting unit determines a first corrected electric current, which has a dependency on the concentration of oxygen gas contained in the measured gas, the concentration of specific gas contained in the measured gas and the reference oxygen sensitivity, from the first output electric current of the first cell, the first reference electric current of the first cell and the reference cell electric current of the reference cell. The detecting unit determines a second corrected electric current, which has a dependency on the concentration of oxygen gas remaining in the measured gas and the reference oxygen sensitivity, from the second output electric current of the second cell, the second reference electric current of the second cell and the reference cell electric current of the reference cell. Then, the detecting unit detects the concentration of specific gas contained in the measured as from the first corrected electric current and the second corrected electric current.

With this structure of the detecting system, the first and second cells are actually manufactured at a predetermined dimensional tolerance so as to inevitably differentiate the size of the first cell from the size of the second cell. Therefore, even when it is desired to manufacture the first and second cells having the same oxygen sensitivity, the first oxygen sensitivity of the first cell is undesirably differentiated from the second oxygen sensitivity of the second cell. Further, the position of the first cell in the detecting system differs from the position of the second cell. Therefore, first conditions (e.g., temperature, pressure and velocity) of the measured gas surrounding the first cell are inevitably differentiated from second conditions of the measured gas surrounding the second cell. This means that the operating conditions of the first cell influenced by the first conditions of the measured gas are differentiated from the operating conditions of the second cell influenced by the second conditions of the measured gas. In this case, it is difficult to detect the specific gas concentration in the measured gas from the difference between the first output electric current of the first cell and the second output electric current of the second cell with high precision.

In the present invention, the first output electric current is corrected to the first corrected electric current by using the first output electric current of the first cell, the first reference electric current of the first cell and the reference cell electric current of the reference cell. The first corrected electric current has no dependency on the first oxygen sensitivity of the first cell but has a dependency on the oxygen gas concentration, the specific gas concentration and the reference oxygen sensitivity. Further, the second output electric current is corrected to the second corrected electric current by using the second output electric current of the second cell, the second reference electric current of the second cell and the reference cell electric current of the reference cell. The second corrected electric current has no dependency on the second oxygen sensitivity of the second cell but has a dependency on the concentration of oxygen gas remaining in the measured gas (e.g., the concentration of oxygen gas not being reacted with the specific gas but remaining in the measured gas) remaining in the measured gas and the reference oxygen sensitivity. That is, the second corrected electric current has a dependency on the reference oxygen sensitivity on which the first corrected electric current has a dependency.

Accordingly, when the specific gas concentration in the measured gas is detected from the first corrected electric current and the second corrected electric current, the detecting system can detect the specific gas concentration in the measured gas with high precision, regardless of the difference in oxygen sensitivity between the first and second cells.

According to the second aspect of this invention, the object is achieved by the provision of a gas sensing device comprising a gas sensor and a gas concentration detecting system. The gas sensor detects the concentration of particular gas contained in measured gas. The detecting system comprises a first cell, a second cell, a reference cell and a gas concentration detecting unit. The first cell has a first sensitivity to oxygen gas, generates a first output electric current, which has a dependency on the first oxygen sensitivity, concentration of oxygen gas contained in the measured gas and concentration of hydrogen gas contained in the measured gas, when the first cell is placed into the measured gas, and generates a first reference electric current, having a dependency on the first oxygen sensitivity, when the first cell is placed into inspection gas containing oxygen gas at a reference concentration. The second cell, having a second sensitivity to oxygen gas, generates a second output electric current, having a dependency on the second oxygen sensitivity and the concentration of oxygen gas remaining in the measured gas, while removing the hydrogen gas from the measured gas when the second cell is placed into the measured gas, and generates a second reference electric current, having a dependency on the second oxygen sensitivity, when the second cell is placed into the inspection gas. The reference cell, having a reference sensitivity to oxygen gas, generates a reference cell electric current, having a dependency an the reference oxygen sensitivity, when the reference cell is placed into the inspection gas. The gas concentration detecting unit determines a first corrected electric current, which has a dependency on the concentration of oxygen gas contained in the measured gas, the concentration of hydrogen gas contained in the measured gas and the reference oxygen sensitivity, from the first output electric current of the first cell, the first reference electric current of the first cell and the reference cell electric current of the reference cell, determines a second corrected electric current, which has a dependency on the concentration of oxygen gas remaining in the measured gas and the reference oxygen sensitivity, from the second output electric current of the second cell, the second reference electric current of the second cell and the reference cell electric current of the reference cell, and detects the concentration of hydrogen gas contained in the measured gas from the first corrected electric current and the second corrected electric current.

With this structure of the gas sensing device, a gas sensor such as an A/F sensor, a NOx sensor, an oxygen sensor or the like is used with the gas concentration detecting system for detecting hydrogen gas concentration in the measured gas. Therefore, the gas sensing device detects the air-fuel ratio, NOx concentration or oxygen concentration in the measured gas while detecting the hydrogen gas concentration in the measured gas.

Accordingly, the air-fuel ratio, NOx concentration or oxygen concentration contained in the measured gas can be detected while the concentration of the hydrogen gas contained in the measured gas is detected with high precision, regardless of the difference in oxygen sensitivity between the first and second cells.

### BRIEF DESCRIPTION OF THE DRAWINGS

FIG. 1 shows a graph indicating the relation between the hydrogen gas concentration in exhaust gas and the current difference I2-I1 calculated according to the prior art;

FIG. 2 is a view schematically showing a hydrogen gas concentration detecting system having a gas sensor according to the first embodiment of the present invention;

FIG. 3 is a flow chart of the processing in the is detection of two reference electric currents performed in the detecting system;

FIG. 4 is a flow chart of the processing in the detection of the hydrogen gas concentration performed in the detecting system;

FIG. 5 shows a graph indicating the relation between the hydrogen gas concentration in measured gas and the hydrogen gas output value ΔI determined in the detecting system shown in FIG. 2;

FIG. 6 is a flow chart showing a rewriting operation performed in a sensor ECU of the detecting system;

FIG. 7 is a flow chart showing another rewriting operation performed in the sensor ECU of the detecting system;

FIG. 8 is a transverse sectional view showing a gas sensor used in the detecting system according to the second embodiment of the present invention;

FIG. 9 is a transverse sectional view showing a gas sensor used in the detecting system according to the third embodiment of the present invention;

FIG. 10 is a longitudinal sectional view showing a gas sensor used in the detecting system according to the fourth embodiment of the present invention;

FIG. 11 is a transverse sectional view taken substantially along line A-A of FIG. 10;

FIG. 12 is a transverse sectional view taken substantially along line B-B of FIG. 10; and

FIG. 13 is a transverse sectional view showing a gas sensor used in the detecting system according to the fifth embodiment of the present invention.

### DETAILED DESCRIPTION OF THE PREFERRED EMBODIMENTS

Embodiments of the present invention will now be described with reference to the accompanying drawings, in which like reference numerals indicate like parts, members or elements throughout the specification unless otherwise indicated.

### First Embodiment

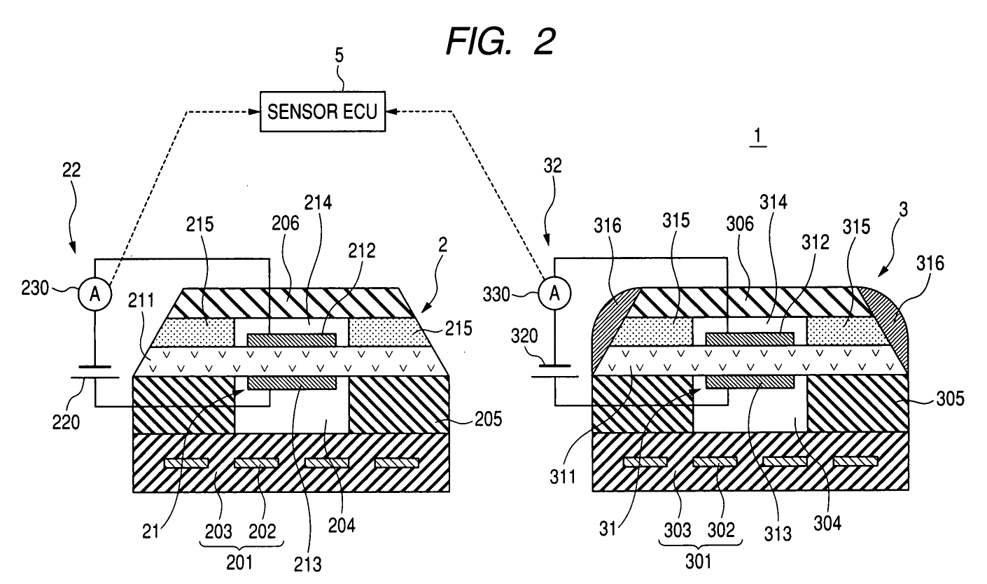

FIG. 2 is a view schematically showing a hydrogen gas concentration detecting system having a gas sensor according to the first embodiment. As shown in FIG. 2, a hydrogen gas concentration detecting system 1 representing a gas concentration detecting system detects or estimates the concentration of hydrogen gas (representing specific gas) contained in measured gas (e.g., exhaust gas) of an internal combustion engine of a vehicle. The measured gas contains reducing gas (e.g., hydro carbons HC not burned in the engine, hydrogen gas H₂, carbon monoxide CO and the like) and oxidizing gas (e.g., oxygen gas O₂ not reacted with the hydro carbons, nitrogen oxides NOx and the like).

The detecting system 1 has a first gas sensing element 2 (see the left sectional view in FIG. 2) for generating a first electric current I1 or Ia from each of the measured gas and inspection gas and detecting the first current, a second gas sensing element 3 (see the right sectional view in FIG. 2) for generating a second electric current I2 or Ib from each of the measured gas not containing hydrogen gas and the inspection gas and detecting the second current, a third gas sensing element (not shown), having the same structure as that of the gas sensing element 2 or 3, for generating a reference cell electric current Ic from the inspection gas and detecting the current, and a sensor electronic control unit (ECU) 5, acting as a gas concentration detecting unit, for detecting the concentration of hydrogen gas contained in the measured gas from the currents I1, I2, Ia and Ib detected in the gas sensing elements 2 and 3 and the reference cell current Ic detected in the third gas sensing element.

When one of the gas sensing elements 2 and 3 is also used as the third gas sensing element, the detecting system 1 has no third gas sensing element, and the sensor ECU 5 detects the hydrogen gas concentration from the currents I1, I2, Ia and Ib detected in the gas sensing elements 2 and 3. A gas sensor of the detecting system 1 is composed of the gas sensing elements 2 and 3 and the third gas sensing element. The inspection gas contains oxygen gas at a reference concentration.

The first gas sensing element 2 has a first electrochemical cell 21, having a first size and being located in an exhaust pipe of the engine, for generating electric current, corresponding to the concentration of oxygen gas contained in the measured gas and the concentration of hydrogen gas contained in the measured gas, when being placed into the measured gas, and generating electric current, corresponding to the reference concentration in the inspection gas when being placed into the inspection gas, and a first current detecting unit 22 for applying a first electric potential difference to electrodes of the cell 21 and detecting the current from the cell 21. The detecting unit 22 has a first battery 220 and a first current detector 230.

The electrochemical cell 21 has a first solid electrolyte body 211 having oxygen ion conductivity, a first measuring electrode 212, having high activity with hydrogen gas and oxygen gas, located on a first principal plane of the electrolyte body 211, a first reference electrode 213 located on a second principal plane of the electrolyte body 211 opposite to the first principal plane, and a first diffusion resistance layer 215 located on the first principal plane of the electrolyte body 211 so as to form a first measured gas chamber 214 surrounded by the resistance layer 215. The resistance layer 215 has a first diffusion resistance against gas.

The first gas sensing element 2 further has a first reference gas chamber forming layer 205 located on the second principal plane of the electrolyte body 211 so as to form a first reference gas chamber 204 surrounded by the forming layer 205, a first shielding plate 206 located on the resistance layer 215 so as to shield the gas chamber 214 surrounded by the resistance layer 215 from the outside of the electrochemical cell 21, and a first heater layer 201 located on the forming layer 205 so as to cover the gas chamber 204 with the heater layer 201 and the forming layer 205.

The gas chamber 214 is communicated with the exhaust pipe to receive the measured gas or the inspection gas therein. The measuring electrode 212 is exposed to the gas of the gas chamber 214. The gas chamber 204 is formed to extend along the longitudinal direction of the cell 21, and reference gas is introduced into the chamber 204 from the proximal side of the chamber 204 in the longitudinal direction to form an atmosphere of the reference gas in the chamber 204. The reference gas contains oxygen gas set at a fixed concentration. More specifically, the gas chamber 204 is communicated with the atmosphere (representing an atmosphere of reference gas) to receive air as the reference gas. The reference electrode 213 is exposed to the reference gas of the gas chamber 204.

The electrolyte body 211 is made of zirconium oxide (i.e., zirconia), cerium dioxide (i.e., cerie) or the like having oxygen ion conductivity and is formed in a sheet shape. Each of the electrodes 212 and 213 is made of cermet and platinum (Pt) and being formed in a porous shape. Therefore, the measuring electrode 212 has activity with the hydrogen gas and the oxygen gas, and the reference electrode 213 has activity with the oxygen gas. A lead line is integrally formed with each of the electrodes 212 and 213, and the current generated between the electrodes 212 and 213 is transmitted to the detecting unit 22 as an electric signal. The forming layer 205 is formed of the lamination of a plurality of ceramic sheets made of alumina. The resistance layer 215 has pores so as to diffuse the measured gas and the inspection gas into the resistance layer 215. The gas diffused into the resistance layer 215 reaches the gas chamber 214. The porosity, the average diameter of the pores and a geometrical figure of the pores in the resistance layer 215 are appropriately set so as to adjust the diffusing rate of the gas at a predetermined value.

The heater layer 201 has a first heater substrate 203, composed of the lamination of a plurality of ceramic sheets, and a first heater 202 buried into the heater substrate 203. The heater 202 is made of platinum (Pt) and cermet formed of ceramics such as alumina. The heater 202 is formed by depositing platinum and cermet onto one ceramic sheet of the substrate 203 according to the patterning formation, and an alumina layer is deposited on the surface of the heater 202 facing the forming layer 205 to insulate the heater 202 from the forming layer 205. The heater 202 generates heat response to electric power supplied to the heater 202 to keep the electrochemical cell 21 at the activation temperature. The cell 21 is activated at the activation temperature.

Each of the electrolyte body 211, the forming layer 205, the shielding plate 206 and the heater layer 201 is formed of the lamination of ceramic sheets. Each of the ceramic sheets is formed according to the doctor blade process, the extrusion molding process or the like. Each of the electrodes 212 and 213 and the lead lines is formed according to the screen printing or the like. The elements assembled into the cell 21 are integrally formed by burning the lamination of ceramic sheets forming the elements 211, 205, 206 and 201.

The second gas sensing element 3 has a second electrochemical cell 31, having a second size and being located in the exhaust pipe, for generating electric current, corresponding to the concentration of oxygen gas contained in the measured gas while removing hydrogen gas from the measured gas, when being placed into the measured gas, and generating electric current, corresponding to the reference concentration in the inspection gas when being placed into the inspection gas, and a second current detecting unit 32 for applying a second electric potential difference to electrodes of the cell 31 and detecting the current from the cell 31. The detecting unit 32 has a second battery 320 and a second current detector 330.

When the second cell 31 is placed into the measured gas, the hydrogen gas in the measured gas is reacted with a part of oxygen gas in the measured gas, so that the hydrogen gas is removed from the measured gas. Therefore, the electric current generated in the second cell 31 depends on the concentration of the remaining part of oxygen gas (hereinafter, called non-reacted oxygen gas) which is not reacted with the hydrogen gas. The concentration of the non-reacted oxygen gas is lower than the concentration of the oxygen gas originally contained in the measured gas.

The second cell 31 has a second solid electrolyte body 311 having oxygen ion conductivity, a second measuring electrode 312 having high activity with oxygen gas and being located on the first principal plane of the electrolyte body 311, a second reference electrode 313 having high activity with oxygen gas and being located on the second principal plane of the electrolyte body 311 opposite to the first principal plane, a second diffusion resistance layer 315 forming a second measured gas chamber 314 so as to structurally separate the gas chamber 314 from the gas chamber 214 of the cell 21, and the catalyst layer 326 disposed on the outer side surface of the resistance layer 315. The resistance layer 315 has a second diffusion resistance against gas. The catalyst layer 316 promotes the oxidization of the measured gas.

The second gas sensing element 3 further has a second reference gas chamber forming layer 305 located on the second principal plane of the electrolyte body 311 so as to form a second reference gas chamber 304 surrounded by the forming layer 305, a second shielding plate 306 located on the resistance layer 315 so as to shield the gas chamber 314 surrounded by the resistance layer 315 from the outside of the second cell 31, and a second heater layer 301 located on the forming layer 305 so as to cover the gas chamber 304 with the heater layer 301 and the forming layer 305. The heater layer 301 has a second heater substrate 303 and a second heater 302.

The constitutional elements of the gas sensing element 3 are formed in the same manner as those of the gas sensing element 2 except that the cell 31 additionally has the catalyst layer 316. In the first cell 21, the resistance layer 215 is directly exposed to the outside of the cell 21, so that the measured gas canoe diffused into the resistance layer 215 without any chemical reaction. In contrast, in the second cell 31, the catalyst layer 316 covers the surface of the resistance layer 315 to prevent the resistance layer 315 from being exposed to the outside of the cell 31. Therefore, before the measured gas is diffused into the resistance layer 315, the hydrogen gas contained in the measured gas is reacted with a portion of the oxygen gas contained in the measured gas in the catalyst layer 316, and the measured gas substantially not containing the hydrogen gas is diffused into the resistance layer 315 and reaches the measuring electrode 312.

The catalyst layer 316 is made of oxidation catalyst such as platinum (Pt) and the ceramics component such as alumina so as to form a porous layer. After the lamination of the elements assembled into the cell 31 not having any catalyst layer is fired so as to integrally form the elements, the fired lamination is dipped into slurry containing the oxidation catalyst and ceramics to attach the slurry onto the surface of the resistance layer 315, and the lamination with the slurry is again fired to form the cell 31 with the catalyst layer 316. The oxidation catalyst of the catalyst layer 316 may be made of at least one of noble metals such as platinum (Pt), palladium (Pd), rhodium (Rh) and silver (Ag). Any of the noble metals can promote the chemical reaction of hydrogen gas with the oxygen gas.

The third gas sensing element has a reference cell (not shown) having a reference oxygen sensitivity. The reference cell has the same structure as that of one of the cells 21 and 31 but has a reference size which differs from or equal to the size of the corresponding cell 21 or 31. That is, the reference cell has a third solid electrolyte body having oxygen ion conductivity, a third measuring electrode located on a first principal plane of the solid electrolyte body, a third reference electrode located on a second principal plane of the third solid electrolyte body opposite to the first principal plane, and a third diffusion resistance layer, located on the first surface of the third solid electrolyte body, through which the inspection gas is introduced into a third measured gas chamber surrounded by the third diffusion resistance layer. The third diffusion resistance layer has a reference diffusion resistance corresponding to the reference oxygen sensitivity.

The detecting system 1 is manufactured at a predetermined dimensional tolerance. Therefore, although it is desired that the size of each constitutional element of the cell 21 is the same as the size of the corresponding constitutional element of the cell 31, the size of each constitutional element of the cell 21 differs from the size of the corresponding constitutional element of the cell 31 by the dimensional tolerance at its maximum. Therefore, the first diffusion resistance of the resistance layer 215 sometimes differs from the second diffusion resistance of the resistance layer 315.

The principle of operation in the detecting system 1 will be described.

In the first electrochemical cell 21, the measured gas surrounding the cell 21 is diffused into the resistance layer 215 and is introduced into the gas chamber 214. The flow rate of each component of the measured gas introduced into the gas chamber 214 is determined by the first diffusion resistance of the resistance layer 215. Further, the detecting unit 22 applies voltage to the cell 21 to set a predetermined electric potential difference between the electrodes 212 and 213. The reference electrode 213 is set as a positive electrode. Therefore, the oxygen gas contained in the measured gas is reduced and ionized to oxygen ions on the measuring electrode 212, and oxygen ions are transferred between the electrodes 212 and 213 through the solid electrolyte body 211 according to the pumping action while generating a first output electric current I1, based on the transfer of the oxygen ions, between the electrodes 212 and 213. The first output current I1 depends on the concentration of the oxygen gas reaching the measuring electrode 212 through the resistance layer 215.

When hydrogen gas is contained in the measured gas, the hydrogen gas and the oxygen gas pass through the resistance layer 215 and reach the gas chamber 214. Because the diffusion velocity of the hydrogen gas is higher than the diffusion velocity of the oxygen gas in the resistance layer 215, the concentration of the oxygen gas reaching the measuring electrode 212 becomes lower than the oxygen gas concentration in the measured gas surrounding the cell 21, while the concentration of the hydrogen gas reaching the measuring electrode 212 becomes higher than the hydrogen gas concentration in the measured gas. Therefore, the first output current I1 depends on the oxygen gas concentration and the hydrogen gas concentration in the measured gas.

In contrast, in the second electrochemical cell 31, the measured gas is initially diffused into the catalyst layer 316. When hydrogen gas is contained in the measured gas, the hydrogen gas is reacted with the oxygen gas contained in the measured gas. The oxygen gas sufficiently exists in the measured gas to react with the hydrogen gas. Then, the measured gas not containing any hydrogen gas is introduced into the gas chamber 314 through the resistance layer 315. The flow rate of each component of the measured gas introduced into the gas chamber 314 is determined by the diffusion resistance of the catalyst layer 316 and the second diffusion resistance of the resistance layer 315. Further, the detecting unit 32 applies voltage to the cell 31 to set a predetermined electric potential difference between the electrodes 312 and 313. The reference electrode 313 is set as a positive electrode. Therefore, the oxygen gas contained in the measured gas is reduced and ionized to oxygen ions on the measuring electrode 312, and oxygen ions are transferred between the electrodes 312 and 313 through the solid electrolyte body 311 according to the pumping action while generating a second output electric current I2, based on the transfer of the oxygen ions, between the electrodes 312 and 313. The second output electric current I2 depends on the concentration of the oxygen gas reaching the measuring electrode 312 through the catalyst layer 316 and the resistance layer 315.

Then, the detecting unit 22 detects the first output current I1, and the detecting unit 32 detects the second output current I2. Because the difference between the first and second output electric currents I1 and I2 is based on the hydrogen gas concentration in the measured gas, the sensor ECU 5 can detect the hydrogen gas concentration in the measured gas from the difference.

Assuming that the sensitivity of the cell 21 to oxygen gas is equal to the sensitivity of the cell 31 to oxygen gas, the sensor ECU 5 can detect the hydrogen gas concentration in the measured gas with high precision. Therefore, to detect the hydrogen gas concentration with high precision, it is required to equalize the oxygen sensitivity of the cell 21 with the oxygen sensitivity of the cell 31. However, because the detecting system 1 is actually manufactured at a predetermined dimensional tolerance, the size of the resistance layer 215 is, for example, inevitably differentiated from the size of the resistance layer 315. Therefore, the oxygen sensitivity of the cell 21 is undesirably differentiated from the oxygen sensitivity of the cell 31. This means that the difference between the first and second output electric currents does not directly indicate the hydrogen gas concentration in the measured gas. In other words, the difference is not changed to be proportional to the hydrogen gas concentration in the measured gas.

Further, the position of the first cell 21 in the exhaust pipe differs from the position of the second cell 31. Therefore, conditions (e.g., temperature, pressure and velocity) of the measured gas surrounding the first cell 21 are inevitably different from conditions of the measured gas surrounding the second cell 31. This means that the operating conditions of the first cell 21 influenced by the first conditions of the measured gas are different from the operating conditions of the second cell 31 influenced by the second conditions of the measured gas. Moreover, the operating temperature of the first cell 21 heated by the heater 202 is sometimes different from the operating temperature of the second cell 31 heated by the heater 302. In this case, because of the difference in the operating conditions between the cells 21 and 31, the oxygen sensitivity of the cell 21 is further differentiated from the oxygen sensitivity of the cell 31.

The inventors of this application found out that, when values I1 and I2 of the output electric currents are corrected by using a value Ia of a first reference electric current generated in the first cell 21 exposed to the inspection gas, a value Ib of a second reference electric current generated in the second cell 31 exposed to the inspection gas, and a value Ic of the reference cell current generated in the reference cell exposed to the inspection gas, the sensor ECU 5 can detect the hydrogen gas concentration in the measured gas from a value Ic×I1/Ia of the first corrected electric current and a value Ic×I2/Ib of the second corrected electric current with high precision.

The inspection gas contains oxygen gas at a reference concentration known in advance but substantially contains no hydrogen gas. When this inspection gas is introduced into the gas chamber 214 through the resistance layer 215, the first reference current Ia is generated in the first cell 21. When this inspection gas is introduced into the gas chamber 314 through the catalyst layer 316 and the resistance layer 315, the second reference current Ib is generated in the second cell 31. When this inspection gas is introduced into a measured gas chamber of the reference cell, the reference cell current Ic is generated in the reference cell. The reference cell has the same structure as that of one of the cells 21 and 31 but has a reference size which differs from or equal to the size of the corresponding cell 21 or 31.

The reason that the sensor ECU 5 can detect the hydrogen gas concentration from the corrected electric currents Ic×I1/Ia and Ic×I2/Ib with high precision will be described. The reference cell has a reference oxygen sensitivity which is determined from the reference size and the operating conditions of the reference cell. A reference cell electric current Ic flowing between electrodes of the reference cell is generated when inspection gas containing oxygen gas at a reference concentration is supplied to a measured gas chamber of the reference cell. In this situation, the first and second output electric currents I1 and I2 are expressed as follows:

I1=ΔS1×ΔC_{OH}×Ic

I2=ΔS2×ΔCo×Ic

where ΔS1 denotes a first sensitivity correction term determined from both the first oxygen sensitivity of the cell 21 and the reference oxygen sensitivity of the reference cell, ΔS2 denotes a second sensitivity correction term determined from both the second oxygen sensitivity of the cell 31 and the reference oxygen sensitivity of the reference cell, ΔC_{OH} denotes a first oxygen gas concentration correction term determined from both a changeable oxygen gas concentration of the measured gas containing hydrogen gas at a changeable hydrogen gas concentration and the reference oxygen gas concentration of the inspection gas, and ΔCo denotes a second oxygen gas concentration correction term determined from the concentration of non-reacted oxygen gas in the measured gas not containing hydrogen gas and the reference oxygen gas concentration of the inspection gas.

The correction term ΔC_{OH} has a dependency on the oxygen gas concentration and the hydrogen gas concentration in the measured gas, while the correction term ΔCo has a dependency only on the concentration of non-reacted oxygen gas in the measured gas.

The difference between the electric currents Ia and Ic is caused only by the difference in oxygen sensitivity between the cell 21 and the reference cell, and the difference between the electric currents Ib and Ic is caused only by the difference in oxygen sensitivity between the cell 31 and the reference cell. Therefore, the first and second reference electric currents Ia and Ib are expressed as follows.

Ia=ΔS1×Ic

Ib=ΔS2×Ic

When an electric current is generated from the measured gas containing oxygen gas and hydrogen gas in the reference cell, the value Ir1 of this electric current is expressed as follows.

$$\begin{matrix}Ir 1 = Δ {C}_{OH} \times {I}_{C} \\ = Ic \times I 1 / Ia\end{matrix}$$

The value Ir1 has a dependency on the oxygen gas concentration and the hydrogen gas concentration. The value Ir1 is determined from the current values I1, Ia and Ic.

When an electric current is generated from the measured gas containing non-reacted oxygen gas but not containing hydrogen gas in the reference cell, the value Ir2 of this electric current is expressed as follows.

$$\begin{matrix}Ir 2 = Δ {C}_{o} \times Ic \\ = Ic \times I 2 / Ib\end{matrix}$$

The value Ir2 has a dependency on the concentration of the non-reacted oxygen gas. Although the concentration of the non-reacted oxygen gas depends on the concentration on the hydrogen gas originally contained in the measured gas, the dependency of the value Ir2 on the hydrogen gas concentration is very small. The value Ir2 is determined from the current values I2, Ib and Ic. Further, each of the values Ir1 and Ir2 has a dependency on the same reference oxygen sensitivity of the reference cell but has no dependency on the first oxygen sensitivity of the first cell or the second oxygen sensitivity of the second cell.

Therefore, a value (e.g., Ir2−Ir1) determined from the values Ir1 and Ir2 can have a dependency on the hydrogen gas concentration but can have no dependency on any oxygen sensitivity or the oxygen gas concentration. When the detecting system 1 detects the hydrogen gas concentration in the measured gas from the value Ir1 determined from the current values I1, Ia and Ic and the value Ir2 determined from the current values I2, Ib and Ic, the detected hydrogen gas concentration can have no dependency on any oxygen sensitivity or the oxygen gas concentration.

Accordingly, the detecting system 1 can detect the hydrogen, gas concentration with high precision.

For example, the difference between the electric currents Ir1 and Ir2 can reliably have no dependency on any oxygen sensitivity. When the hydrogen gas concentration in the measured gas is, for example, determined from the difference ΔI=Ir2−Ir1 between the electric currents Ir1 and Ir2, the detecting system 1 can detect the hydrogen gas concentration in the measured gas such that the detected hydrogen gas concentration has no dependency on any oxygen sensitivity or the oxygen gas concentration.

Accordingly, the detecting system 1 can detect the hydrogen gas concentration in the measured gas from the difference ΔI=Ic×I2/Ib−Ic×I1/Ia with high precision.

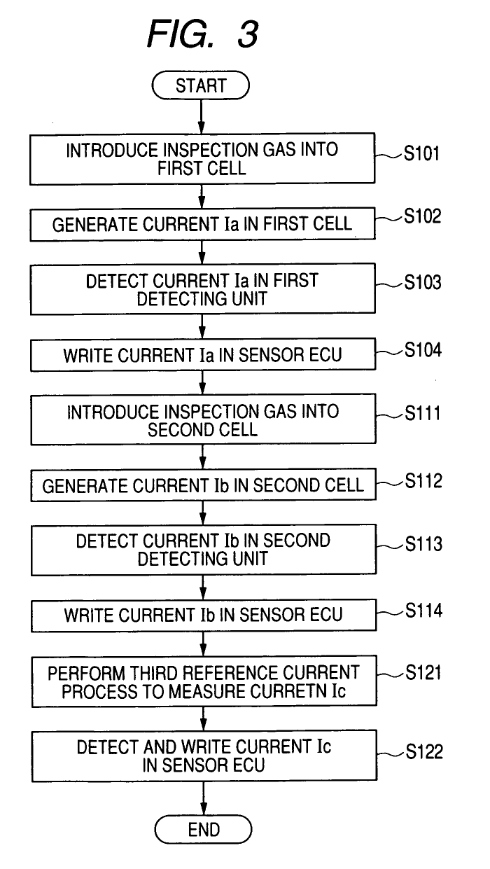

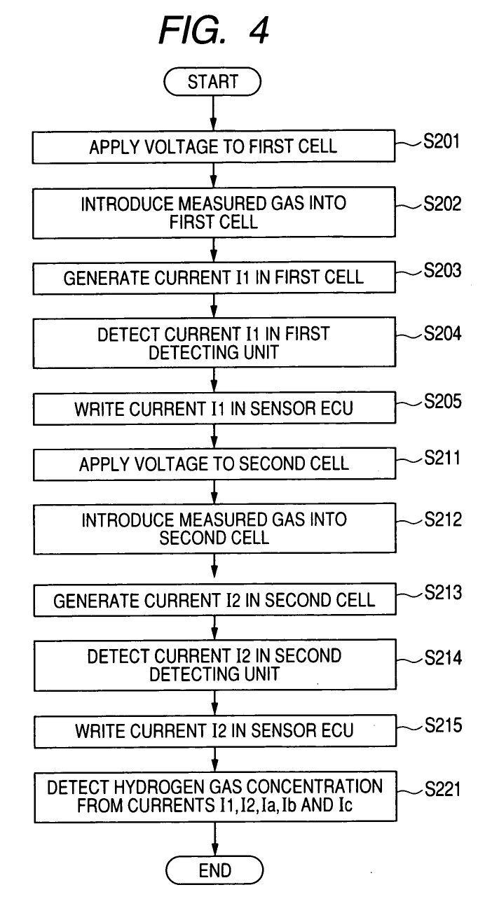

The detection of the hydrogen gas concentration in the measured gas will be described in more detail with reference to FIG. 3 and FIG. 4. FIG. 3 is a flow chart of the processing in the detection of the currents Ia and Ib, while FIG. 4 is a flow chart of the processing in the detection of the hydrogen gas concentration.

For the inspection of sensor characteristics, the first reference current process is performed for the first gas sensing element 2 to measure the first reference current Ia, and the second reference current process is performed for the second gas sensing element 3 to measure the second reference current Ib. Although the inspection oxygen gas concentration of the inspection gas should be fixed, it is preferred that the inspection oxygen gas concentration is known in advance. In this example, the inspection gas with an oxygen gas concentration of about 21% is used. For example, air is used as the inspection gas.

As shown in FIG. 3, in the first reference current process, the inspection gas not containing hydrogen gas is introduced into the gas chamber 214 of the first cell 21 while the reference gas is introduced into the gas chamber 204 (step S101), the first current Ia flowing between the electrodes 212 and 213 is generated in the first cell 21 (step S102), the detecting unit 22 detects the first current Ia (step S103), and the detected current Ia is written in the sensor ECU 5 (step S104). The first current Ia is, for example, 1.6 mA. In the second reference current process, the inspection gas not containing hydrogen gas is introduced into the gas chamber 314 of the second cell 31 while the reference gas is introduced into the gas chamber 304 (step S111), the second current Ib flowing between the electrodes 312 and 313 is generated in the second cell 31 (step S112), the detecting unit 32 detects the value Ib of the second current (step S113), and the detected current Ib is written in the sensor ECU 5 (step S114). The value Ib of the second current is, for example, 1.7 mA.

Further, a third reference current process is performed by using a reference cell. In this process, at step S121, the inspection gas and reference gas are introduced into respective gas chambers of the reference cell to measure the reference cell current Ic flowing in the reference cell. Then, at step S122, the current Ic is detected and written in the sensor ECU 5. To simplify the reference current processes, one of the cells 21 and 31 may be set as the reference cell. When the first cell 21 is set as the reference cell, the value Ic of the reference cell current is the same as the value Ia of the first reference current. In contrast, when the second cell 31 is set as the reference cell, the value Ic of the reference cell current is the same as the value Ib of the second reference current. In this example, the first cell 21 is set as the reference cell, and the value Ic of the reference cell current is 1.6 mA.

Thereafter, the first measuring process is performed by using the gas sensing element 2 to measure the first output current I1, and the second measuring process is performed by using the gas sensing element 3 to measure the second output current I2.

As shown in FIG. 4, in the first measuring process, the detecting unit 22 applies voltage to the first cell 21 to set a predetermined electric potential difference between the electrodes 212 and 213 (step S201), the measured gas containing oxygen gas and hydrogen gas is introduced into the gas chamber 214 of the first cell 21 through the resistance layer 215 while the reference gas is introduced into the gas chamber 204 (step S202), the first output current I1 flowing between the electrodes 212 and 213 (step S203) is generated in the first cell 21, the first detecting unit 22 detects the first output current I1 (step S204) and the detected current I1 is written in the sensor ECU 5 (step S205). The first output electric current I1 is, for example, equal to 0.25 mA in case of the oxygen gas concentration of 20% and the hydrogen gas concentration of 3% in the measured gas. In the second measuring process, the detecting unit 32 applies voltage to the second cell 31 to set a predetermined electric potential difference between the electrodes 312 and 313 (step S211). Then, the measured gas is introduced into the gas chamber 214 through the resistance layer 315, while the reference gas is introduced into the gas chamber 304 (step S212). Therefore, the hydrogen gas contained in the measured gas is reacted with the oxygen gas contained in the measured gas in the catalyst layer 316, and the measured gas not containing the hydrogen gas is introduced into the gas chamber 314. Then, the second output current I2 flowing between the electrodes 312 and 313 is generated in the second cell 31 (step S213), the second detecting unit 32 detects the second output current I2 (step S214), and the detected current I2 is written in the sensor ECU 5 (step S215). The second output electric current I2 is, for example, equal to 0.52 mA in case of the oxygen gas concentration of 20% and the hydrogen gas concentration of 3% in the measured gas.

Thereafter, the sensor ECU 5 determines the value Ic×I1/Ia of the first corrected electric current and the value Ic×I2/Ib of the second corrected electric current from the currents Ia, Ib, Ic, I1 and I2, and detects the hydrogen gas concentration in the measured gas from the corrected currents (step S221). For example, the sensor ECU 5 determines the difference ΔI=I2/Ib−Ic×I1/Ia between the corrected currents as a hydrogen gas output value and detects the hydrogen gas concentration from the hydrogen gas output value ΔI. In this embodiment, the hydrogen gas output value ΔI is equal to 0.24 mA, and the sensor ECU 5 detects the hydrogen gas concentration of 3%.

For example, the sensor ECU 5 prepares in advance an equation, which indicates the correlation between the hydrogen gas output value ΔI and the hydrogen gas concentration in the measured gas, by using many samples of sampling gas containing oxygen gas and hydrogen gas. Then, the sensor ECU 5 detects the hydrogen gas concentration in the measured gas from the hydrogen gas output value ΔI by using this correlation equation.

Therefore, although the output electric current I1 is influenced by the actual size of the first cell (i.e., the actual diffusion resistance of the resistance layer 215), the value Ic×I1/Ia of the first corrected electric current is not influenced by the actual size of the first cell 21. In the same manner, although the second output current I2 is influenced by the actual size of the second cell 31 (i.e., the actual diffusion resistance of the resistance layer 315), the value Ic×I2/Ib of the second corrected electric current is not influenced by the actual size of the first cell 31.

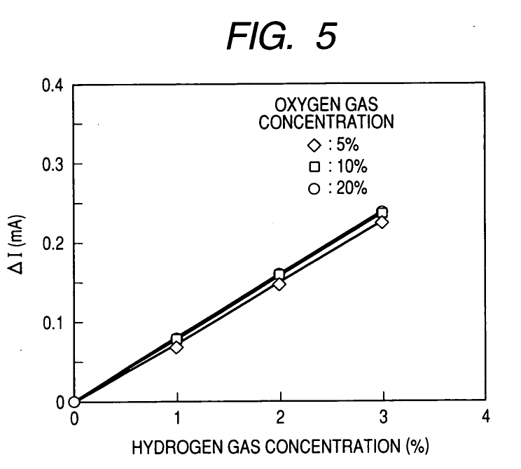

Effects in this embodiment will be described with reference to FIG. 5. FIG. 5 shows a graph indicating the relation between the hydrogen gas concentration of the measured gas and the hydrogen gas output value ΔI determined in the detecting system 1.

Twelve samples of the measured gas are prepared. In each sample, the oxygen gas concentration in the measured gas is set at 5%, 10% or 20%, and the hydrogen gas concentration in the measured gas is set at 0%, 1%, 2% or 3%. The relation at the oxygen gas concentration of 5% is indicated by the symbol ⋄, the relation at the oxygen gas concentration of 10% is indicated by the symbol □, and the relation at the oxygen gas concentration of 20% is indicated by the symbol ◯.

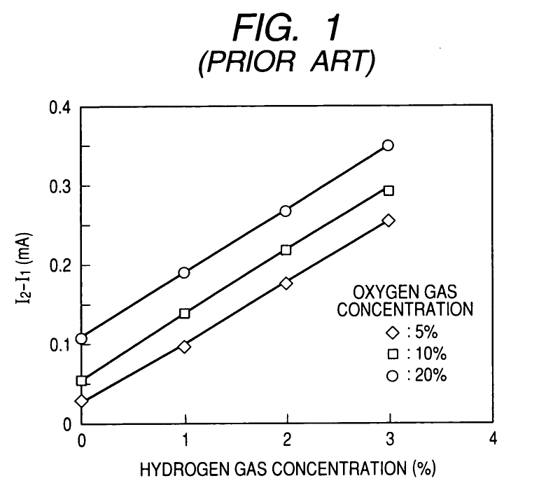

As shown in FIG. 5, the hydrogen gas output values ΔI in the samples set at the same hydrogen gas concentration substantially have the same value, regardless of the oxygen gas concentration. Therefore, although the difference I2−I1 determined according to the prior art has a dependency on the oxygen gas concentration (see FIG. 1), it will be realized that the hydrogen gas output value ΔI shown in FIG. 5 is substantially independent of the oxygen gas concentration.

Accordingly, because the hydrogen gas concentration in the measured gas is detected from the value Ic×I1/Ia of the first corrected electric current and the value Ic×I2/Ib of the second corrected electric current, the detecting system 1 can detect the hydrogen gas concentration in the measured gas with high precision, regardless of the difference between the actual diffusion resistances of the resistance layers 215 and 315 (i.e., the difference between the first oxygen sensitivity of the first cell 21 and the second oxygen sensitivity of the second cell 31). That is, the hydrogen gas concentration in the measured gas can be precisely detected without being influenced by the diffusion resistance difference.

For example, because each of the cells 21 and 31 is manufactured at a certain dimensional tolerance, it is difficult to equalize the size of the resistance layer 215 with the size of the resistance layer 315. Therefore, the diffusion velocity of the oxygen gas in the resistance layer 215 differs from the diffusion velocity of the oxygen gas in the resistance layer 315, so that the oxygen sensitivity of the cell 21 is undesirably differentiated from the oxygen sensitivity of the cell 31. Further, because of the difference between the positions of the cells 21 and 23 in the exhaust pipe and the difference between the operating temperatures of the cells 21 and 23, the operating conditions of the first cell 21 are differentiated from the operating conditions of the second cell 31. Therefore, the oxygen sensitivity of the cell 21 is further differentiated from the oxygen sensitivity of the cell 31. As a result, when the hydrogen gas concentration in the measured gas is detected from both the output electric current z1, having a dependency on the oxygen sensitivity of the first cell 21, and the second output current I2 having a dependency on the oxygen sensitivity of the second cell 31, the detected hydrogen gas concentration is considerably differentiated from the actual hydrogen gas concentration. However, the value Ic×I1/Ia of the first corrected electric current has no dependency on the oxygen sensitivity of the cell 21 but has a dependency on the oxygen sensitivity of the reference cell, and the value Ic×I2/Ib of the second corrected electric current has no dependency on the oxygen sensitivity of the cell 31 but has a dependency on the oxygen sensitivity of the reference cell. Because the hydrogen gas concentration in the measured gas is detected from the value Ic×I1/Ia of the first corrected electric current and the value Ic×I2/Ib of the second corrected electric current according to the first embodiment, the hydrogen gas concentration in the measured gas can be precisely detected. For example, the hydrogen gas concentration can be detected from the hydrogen gas output value ΔI=Ic×I2/Ib−Ic×I1/Ia.

Further, because air substantially not containing hydrogen gas is used as the inspection gas, the hydrogen gas concentration can be easily detected from both the value Ic×I1/Ia of the first corrected electric current having a dependency on the concentration of the hydrogen gas, a dependency on the concentration of the oxygen gas and the value Ic×I2/Ib of the second corrected electric current having a dependency on the concentration of the non-reacted oxygen gas. Accordingly, the hydrogen gas concentration in the measured gas can be further precisely detected.

Moreover, because the first cell 21 is used as the reference cell, the value Ic of the reference cell current can be set at the value Ia of the first reference current without the third reference current process. Accordingly, the detection of the hydrogen gas concentration can be easily performed without using the reference cell.

Furthermore, the catalyst layer 316 of the second cell 31 is made of at least one of noble metals such as platinum (Pt), palladium (Pd), rhodium (Rh) and silver (Ag). Accordingly, the hydrogen gas in the measured gas can be sufficiently reacted with the oxygen gas.

In this embodiment, each of the gas sensing elements 2 and 3 is preferably of a limiting current type. The limiting current type gas sensing element has characteristics that the electric current flowing between electrodes of the gas sensing element becomes constant in a limiting current zone of the electric potential difference set between the electrodes. This limiting current zone is changed with the oxygen gas concentration in the measured gas. Therefore, even when the electric potential difference is changed in the limiting current zone, the electric current substantially has a constant limiting current value corresponding to the oxygen gas concentration. This constant electric current is changed with the oxygen gas concentration to be substantially proportional to the oxygen gas concentration. When the electric potential difference is set such that each of the electric currents I1, I2, Ia and Ib reliably becomes a constant value corresponding to the oxygen gas concentration in the limiting current zone, electric currents I1, I2, Ia and Ib can be precisely and easily detected in the detecting units 22 and 32. Accordingly, the detecting system 1 can further precisely detect the hydrogen gas concentration.

Further, in this limiting current type gas sensing element, to measure each of the electric currents I1, I2, Ia and Ib, the electric potential difference may be set at a constant value such that the electric potential difference is always placed in the limiting current zone regardless of a change in the oxygen gas concentration. In this case, the reference current processes shown in FIG. 3 and the measuring processes shown in FIG. 4 can be easily performed. In contrast, the electric potential difference may be changed with the oxygen gas concentration in the measured gas such that the electric potential difference is placed near the middle point of the limiting current zone. In this case, the precision in the detection of the hydrogen gas concentration can be heightened.

In this embodiment, the hydrogen gas output value ΔI=Ic×I2/Ib−Ic×I1/Ia is determined from the equations I1=ΔS1×ΔC_{OH}×Ic and I2=ΔS2×ΔCo×Ic. However, the hydrogen gas output value ΔI may be determined from equations I1=ΔS1+ΔC_{OH}+Ic and I2=ΔS2+ΔCo+Ic or the like. Therefore, the determination of the hydrogen gas output value ΔI is not limited to the equation ΔI=Ic×I2/Ib−Ic×I1/Ia. The hydrogen gas output value ΔI can be obtained from the currents I1, I2, Ia, Ib and Ic.

In this embodiment, the first cell 21 is used as the reference cell to regard the oxygen sensitivity of the first cell 21 as the reference oxygen sensitivity. However, the second cell 31 may be used as the reference cell to regard the oxygen sensitivity of the second cell 31 as the reference oxygen sensitivity.

In this embodiment, the inspection gas substantially contains no hydrogen gas. However, the inspection gas may contain hydrogen gas at a known concentration.

In this embodiment, the hydrogen gas concentration in the measured gas is detected. However, the concentration of specific gas such as air, oxygen gas, NOx or the like contained in the measured gas may be detected.

In this embodiment, the sensor ECU 5 determines the hydrogen gas output value ΔI=Ic×I2/Ib−Ic×I1/Ia from the corrected currents, and the sensor ECU 5 detects the hydrogen gas concentration from the hydrogen gas output value ΔI. However, the hydrogen gas output value ΔI sometimes has a dependency on the oxygen gas concentration in the measured gas even when the hydrogen gas concentration in the measured gas is constant. In this case, to precisely detect the hydrogen gas concentration, the oxygen gas concentration is detected from the first output current I1 or the second output current I2, and the hydrogen gas concentration detected from the hydrogen gas output value ΔI is corrected according to the detected oxygen gas concentration.

Accordingly, even when the hydrogen gas output value ΔI has a dependency on the oxygen gas concentration in the measured gas, the hydrogen gas concentration can be precisely detected.

The oxygen gas concentration used for the correction of the hydrogen gas output value ΔI may be detected from either the first output current I1 or the second output current I2. However, the first output current I1 is changed with the hydrogen gas concentration. In contrast, because the second output current I2 is generated after the removal of the hydrogen gas from the measured gas on the catalyst layer 316 due to the reaction of the hydrogen gas with a part of the oxygen gas, a dependency of the second output current I2 on the hydrogen gas concentration is very low. Therefore, it is preferred that the oxygen gas concentration be detected from the second output current I2.

A gas sensing device may be composed of the detecting system 2 and a gas sensor such as an A/F sensor, a NOx sensor, an oxygen sensor or the like. The sensor ECU 5 may detect the air-fuel ratio, the NOx concentration or the oxygen concentration in the measured gas from air and fuel detected in the A/F sensor, NOx detected in the NOx sensor or oxygen detected in the oxygen sensor Accordingly, the gas sensing device can detect the air-fuel ratio, the NOx concentration or the oxygen concentration in the measured gas while detecting the hydrogen gas concentration in the measured gas with high precision.

### First Modification

An example of the correction of the hydrogen gas output value ΔI performed by using the detected oxygen gas concentration will be described in detail. The oxygen gas concentration is detected from the second output current I2.

Many samples of sampling gas containing oxygen gas and hydrogen gas are prepared in advance. The oxygen gas concentration and the hydrogen gas concentration in the samples are known and are, respectively, set at intervals of predetermined values. Then, each sample is used for a first sampled cell having no catalyst layer and a second sampled cell having the same catalyst layer as the catalyst layer 316, and the hydrogen gas output value ΔI is calculated for each value of the oxygen and hydrogen gas concentrations. Then, the relation between the hydrogen gas concentration C_{H} and the hydrogen gas output value ΔI is determined for each value of the oxygen gas concentration.

Assuming that the hydrogen gas output value ΔI is not influenced by the oxygen gas concentration, the idealistic relation C_{H}=A×ΔI (A denotes a constant) is satisfied. The sensor ECU 5 stores the constant ΔI in advance. When the hydrogen gas output value ΔI receives influence of the oxygen gas concentration, the actual relation C_{H}=A×{(ΔI+Y (Cₒ))×X(Cₒ)} is satisfied for each value Cₒ of the oxygen gas concentration. The value Y is determined from the value −Y of the current ΔI at the first offset paint (i.e., ΔI-intercept) at which the hydrogen gas concentration becomes zero. The value X is determined from the value AXY of the hydrogen gas concentration at the second offset point (i.e., C_{H}-intercept) at which the hydrogen gas output value ΔI becomes zero. The sensor ECU 5 stores the values Y(Cₒ) and X (Cₒ) in advance for each value Cₒ of the oxygen gas concentration.

When the sensor ECU 5 calculates the output current ΔI, the sensor ECU 5 determines a corrected output current ΔIc=(ΔI+Y(Cₒ))×X(Cₒ) from the oxygen gas concentration Cₒ detected from the second output current I2. Then, the sensor ECU 5 detects the hydrogen gas concentration C_{H}=A×{((ΔI+Y(Cₒ))×X(Cₒ)}.

Accordingly, even when the hydrogen gas output value ΔI receives influence of the oxygen gas concentration, the hydrogen gas concentration in the measured gas can be precisely detected.

### Second Modification

In the first embodiment, the sensor ECU 5 performs the first and second reference current processes shown in FIG. 3 only once to measure the reference electric currents Ia and Ib. The values of the currents Ia and Ib are fixed. In contrast, in this modification, the sensor ECU 5 repeatedly performs the first and second reference current processes to rewrite or update the currents Ia and Ib. Each time the sensor ECU 5 performs the first and second reference current processes, the sensor ECU 5 replaces the currents Ia and Ib already stored to the currents Ia and Ib presently measured. More specifically, each time the operation of the engine is stopped, the sensor ECU 5 waits until the cells 21 and 31 are placed in an atmosphere of the inspection gas (i.e., air having the oxygen gas concentration of about 21%). Then, the sensor ECU 5 measures the currents Ia and Ib and rewrites or renews the currents Ia and Ib previously measured to the currents Ia and Ib presently measured.

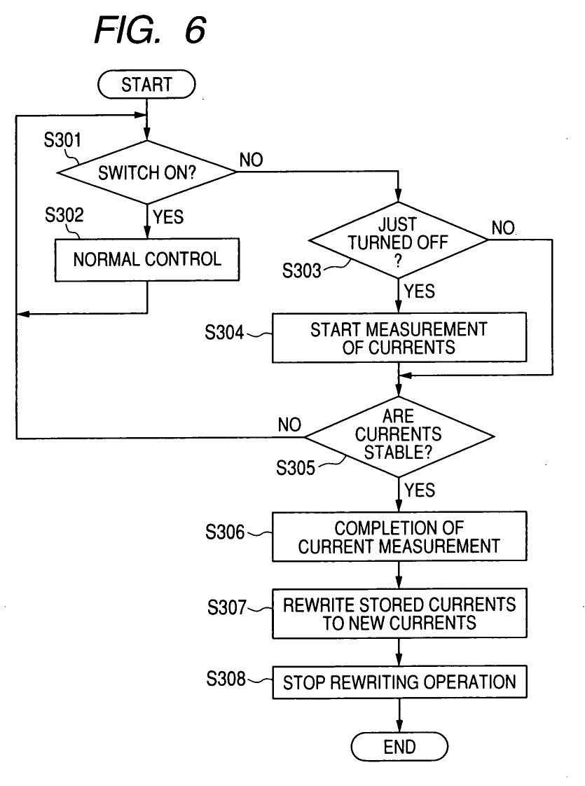

An example of the operation for rewriting the currents Ia and Ib will be described with reference to FIG. 6. FIG. 6 is a flow chart showing the rewriting operation of the currents Ia and Ib. In this example, one of the cells 21 and 31 is used as the reference cell, so that the value of the reference cell current Ic is equal to the value of one of the reference electric currents Ia or Ib.

As shown in FIG. 6, at step S301, it is judged whether or not an ignition switch of the vehicle having the detecting system 1 is set in the on state. When the ignition switch is set in the on state (YES at step S301), it is judged that the engine is now operated. Therefore, at step S302, the first and second measuring processes (see FIG. 4) in the normal control are performed to measure first and second output electric currents I1 and I2, to determine the hydrogen gas output value ΔI from the output electric currents I1 and I2 and the reference electric currents Ia and Ib previously measured and to detect the hydrogen gas concentration in the measured gas from the hydrogen gas output value ΔI.

In contrast, when the ignition switch is set in the off state (NO at step S301), at step S303, it is judged whether or not the ignition switch is just turned off. In the case of an affirmative judgment at step S303, it is judged that the replacement of the measured gas in the exhaust pipe with air is just started. Therefore, at step S304, the measurement of the currents Ia and Ib is started. More specifically, the measurement of both the current flowing between the electrodes 212 and 213 and the current flowing between the electrodes 312 and 313 is started. In contrast, in the case of a negative judgment at step S303, because the measurement of the currents Ia and Ib has been already started, the procedure proceeds to step 5205.

At step S305, it is judged whether or not the output electric currents are stable. For example, when five values of each current recently measured are placed within a predetermined range, it is judged that the output electric current is stable. When at least one of the output electric currents is not stable (NO at step S305), it is judged that the measured gas in the exhaust pipe is not yet sufficiently replaced with air. In this case, the output electric currents are not adequate as currents Ia and Ib. Therefore, the procedure returns to step S301. In contrast, when the output electric currents become stable (YES at step S305), at step S305, the output electric currents are adopted as currents Ia and Ib, and the measurement of the currents Ia and Ib is completed. Then, at step S307, the currents Ia and Ib newly measured are stored in a memory of the sensor ECU 5 to rewrite stored data to the newly-output electric currents Ia and Ib. Then, at step S308, the rewriting operation of the currents Ia and Ib in the detecting system 1 is stopped.

In this rewriting operation, the measurement of the current Ia and the measurement of the current Ib may be separately performed. For example, when the current in the measurement of the current Ia becomes stable at step S305 while the current in the measurement of the current Ib is not stable, the measurement of the current Ia is completed, while the measurement of the current Ib is still continued.

The cells 21 and 31 are operated during the operation of the engine. Therefore, the performance of the cells 21 and 31 is changed with time due to the ageing of the cells 21 and 31. Especially, because the measured gas passes through the diffusion resistance layers 215 and 315 of the cells 21 and 31 during the operation of the engine, the diffusion resistance in each of the diffusion resistance layers 215 and 315 is changed with time, and the reference electric currents Ia or Ib are changed with the diffusion resistance. Assuming that the values of the currents Ia or Ib are fixed, it is sometimes difficult to precisely determine the hydrogen gas output value ΔI from the currents Ia or Ib. To always precisely determine the hydrogen gas output value ΔI, each time the operation of the engine is stopped, the currents Ia or Ib are measured during the stopping period between operations of the engine.

Accordingly, because the currents Ia or Ib are updated, the detecting system 1 can always detect the hydrogen gas concentration in the measured gas with high precision.

### Third Modification

In this modification, each time the cells 21 and 31 are exposed to the inspection gas, the sensor ECU 5 measures the currents Ia and Ib and rewrites stored data of the currents Ia and Ib previously measured to the currents Ia and Ib presently measured. More specifically, the fuel supplied to the engine is sometimes cut during the operation of the engine, so that the measured gas of the exhaust pipe is replaced with the inspection gas such as air. Each time this fuel cut operation is performed, the sensor ECU 5 measures the currents Ia and Ib and rewrites or renews the currents Ia and Ib previously measured to the currents Ia and Ib presently measured.

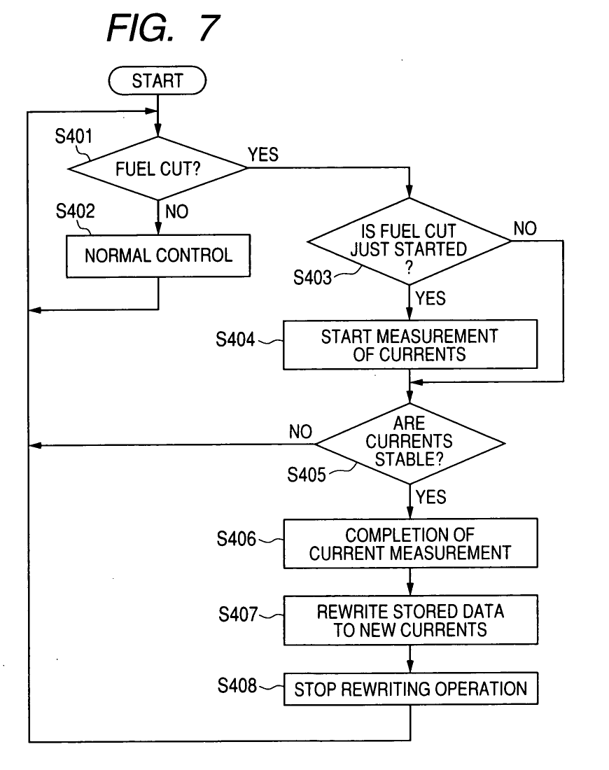

An example of the operation for rewriting the currents Ia and Ib will be described with reference to FIG. 7. FIG. 7 is a flow chart showing the rewriting operation of the currents Ia and Ib. In this example, one of the cells 21 and 31 is used as the reference cell, so that the value of the reference cell current Ic is equal to the value of one of the reference electric currents Ia or Ib.

As shown in FIG. 7, at step S401, it is judged whether or not the operation of the fuel cut is now going on in the detecting system 1. This fuel cut is performed when operating states of the engine such as an engine speed satisfy predetermined levels during the driving of the vehicle. Therefore, the judgment on the fuel cut can be performed according to the operating states of the engine.

When the fuel cut is not performed (NO at step S401), at step S402, the first and second measuring processes (see FIG. 4) in the normal control are performed to measure first and second output electric currents I1 and I2, to determine the hydrogen gas output value ΔI from the output electric currents I1 and I2 and the reference electric currents Ia and Ib previously measured and to detect the hydrogen gas concentration in the measured gas from the hydrogen gas output value ΔI.

In contrast, when the fuel cut is now going on (YES at step S401), at step S403, it is judged whether or not the fuel cut is just started. In the case of an affirmative judgment at step S403, it is judged that is the replacement of the measured as in the exhaust pipe with air is just started. Therefore, at step S404, the measurement of the currents Ia and Ib is started. In contrast, in the case of a negative judgment at step S403, because the measurement of the currents Ia and Ib has been already started, the procedure proceeds to step S405.

At step S405, it is judged whether or not the output electric currents are stable. For example, when five values of each current recently measured are placed within a predetermined range, it is judged that the output electric current is stable. When at least one of the output electric currents is not stable, it is judged that the measured gas in the exhaust pipe is not yet sufficiently replaced with air. In this case, the output electric currents are not adequate as currents Ia and Ib. Therefore, the procedure returns to step S401. In contrast, when the output electric currents become stable, at step S406, the output electric currents are adopted as currents Ia and Ib, and the measurement of the currents Ia and Ib is completed. Then, at step S407, the currents Ia and Ib newly measured are stored in a memory of the sensor ECU 5 to rewrite stored data to the newly-output electric currents Ia and Ib. Then, at step S408, the rewriting operation of the currents Ia and Ib in the detecting system 1 is stopped, and the normal control is performed to measure first and second output electric currents I1 and I2.

In this rewriting operation, the measurement of the current Ia and the measurement of the current Ib may be separately performed. For example, when the current in the measurement of the current Ia becomes stable at step S405 while the current in the measurement of the current Ib is not stable, the measurement of the current Ia is completed, while the measurement of the current Ib is still continued.

During the fuel cut, the supply of the measured gas from the engine to the exhaust pie is stopped, and the measured gas of the exhaust pipe is replaced with air (i.e., inspection gas). In this modification, the currents Ia and Ib are measured when the measured gas is sufficiently replaced with air during the fuel cut. Especially, during the fuel cut, no fuel is supplied to the engine, but air is supplied to the engine. Therefore, air supplied to the engine is outputted to the exhaust pipe so as to replace the measured gas of the exhaust pipe with air. This replacement is performed in a short time, and the cells 21 and 31 are soon placed in an atmosphere of air (i.e., the oxygen concentration of about 21%).

Accordingly, because the currents Ia or Ib are updated every fuel cut, the detecting system 1 can always detect the hydrogen gas concentration in the measured gas with high precision.

Further, when the fuel cut is performed many times in one driving operation between engine stopping operations, the rewriting of the currents Ia and Ib can be frequently performed. Accordingly, the detecting system 1 can further precisely detect the hydrogen gas concentration in the measured gas, as compared with the detection according to the second modification.

### Second Embodiment

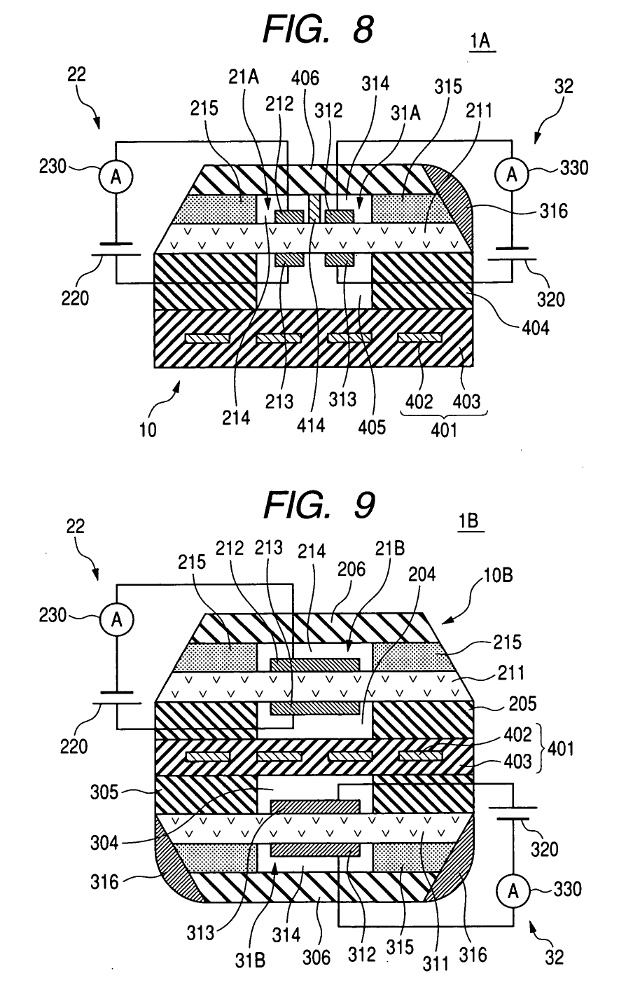

FIG. 8 is a transverse sectional view showing a gas sensor of the detecting system according to the second embodiment.

As shown in FIG. 8, a hydrogen gas concentration detecting system 1A representing a gas concentration detecting system has a gas sensor 10 with two cells, located in the exhaust pipe of the engine, and the sensor ECU 5 (not shown).

The gas sensor 10 has the solid electrolyte body 211, the measuring electrodes 212 and 312 located on the first principal plane of the electrolyte body 212, the reference electrodes 213 and 313 located on the second principal plane of the electrolyte body 211, the diffusion resistance layers 215 and 315 located on the first principal plane of the electrolyte body 211, the catalyst layer 316 disposed on the outer side surface of the resistance layer 315, and a partitioning wall 414 located on the first principal plane of the electrolyte body 211. The wall 414 structurally separates the gas chamber 214, surrounded by the layer 215, from the second gas chamber 314 surrounded by the layer 315.

A first electrochemical cell 21A is composed of the electrolyte body 211, the electrodes 212 and 213, the resistance layer 215 and the partitioning wall 414. A second electrochemical cell 31A is composed of the electrolyte body 211, the electrodes 312 and 313, the resistance layer 315, the catalyst layer 316 and the partitioning wall 414. The first cell 21A has the first oxygen sensitivity corresponding to the resistance layer 215, while the second cell 31A has the second oxygen sensitivity corresponding to the resistance layer 315.

The gas sensor 10 further has a reference gas chamber forming layer 404 located on the second principal plane of the electrolyte body 211 so as to form a reference gas chamber 405 surrounded by the forming layer 404, a shielding plate 406 located on the resistance layers 215 and 315 so as to shield the gas chambers 214 and 314 surrounded by the resistance layers 215 and 315 and the partitioning wall 414 from the outside of the sensor 10, and a heater layer 401 located on the forming layer 404 so as to cover the gas chamber 405 with the heater layer 401 and the forming layer 404. In the same manner as the gas chambers 204 and 304, the gas chamber 405 is formed to extend along the longitudinal direction of the gas sensor 10, and the reference gas is introduced into the chamber 405 from the proximal side of the chamber 405 in the longitudinal direction to form an atmosphere of the reference gas in the chamber 405. In the same manner as the heater layers 201 and 301, the heater layer 401 has a heater substrate 403 and a heater 402 to heat the gas sensor 10 at an active temperature.

The gas sensor 10 further has the detecting unit 22 for applying a predetermined electric potential difference to the electrodes 212 and 213 of the cell 21A and detecting the electric current from the cell 21A, and the detecting unit 32 for applying a predetermined electric potential difference to electrodes 312 and 313 of the cell 31A and detecting the electric current from the cell 31A.

Because the gas chambers 214 and 314 are separated from each other by the partitioning wall 414, the first cell 21A acts in the same manner as the first cell 21 shown in FIG. 2, and the second cell 31A acts in the same manner as the second cell 31 shown in FIG. 2. More specifically, the measuring electrode 212 of the cell 21A is exposed to the measured gas containing oxygen gas and hydrogen gas in the gas chamber 214, while the measuring electrode 312 of the cell 31A is exposed to the measured gas containing oxygen gas but not containing hydrogen gas in the gas chamber 314. The reference electrodes 213 and 313 of the cells 21A and 31A are exposed to the reference gas together in the gas chamber 405. Therefore, the output electric currents I1 and I2 are generated in the cells 21A and 31A, and the detecting units 22 and 32 detect the output electric currents I1 and I2. Further, the measuring electrodes 212 and 312 are sometimes exposed to the inspection gas to generate the reference electric currents Ia and Ib in the cells 21A and 31A.

Accordingly, even when the diffusion resistance of the resistance layer 215 for the measured gas differs from the diffusion resistance of the resistance layer 315 so as to differentiate the first oxygen sensitivity of the first cell 21A from the second oxygen sensitivity of the second cell 31A, the detecting system 1A can detect the hydrogen gas concentration in the measured gas with high precision in the same manner as the detecting system 1 shown in FIG. 2.

Further, because the cells 21A and 31A are integrally formed with each other so as to use the electrolyte body 211 together, the cells 21A and 31A in the exhaust pipe are placed substantially at the same position. Moreover, the cells 21A and 31A are heated by the heater 402 together, so that the cells 21A and 31A are set at the same temperature. Therefore, the operating conditions of the first cell 21A are set to be the same as the operating conditions of the first cell 31A. In this case, the difference in the oxygen sensitivity between the first and second cells 21A and 31A is reduced.

Accordingly, the detecting system 1A can further precisely detect the hydrogen gas concentration in the measured gas.

In this embodiment, the reference electrodes 213 and 313 are separately formed so as to be electrically disconnected from each other. However, because the measured electrodes 212 and 312 are electrically disconnected from each other, the reference electrodes 213 and 313 may be integrally formed with each other so as to be electrically connected with each other.

Further, each of the modifications in the first embodiment can be applied for the detecting system 1A.

A gas sensing device may be composed of the detecting system 1A and a gas sensor such as an A/F sensor, a NOx sensor, an oxygen sensor or the like. The sensor ECU 5 shown in FIG. 2 may detect the air-fuel ratio, the NOx concentration or the oxygen concentration in the measured gas from air and fuel detected in the A/F sensor, NOx detected in the NOx sensor or oxygen detected in the oxygen sensor. Accordingly, the gas sensing device can detect the air-fuel ratio, the NOx concentration or the oxygen concentration in the measured gas while detecting the hydrogen gas concentration in the measured gas with high precision.

### Third Embodiment

FIG. 9 is a transverse sectional view showing a gas sensor of the detecting system according to the third embodiment.

As shown in FIG. 9, a hydrogen gas concentration detecting system 1B representing a gas concentration detecting system has a gas sensor 10B with two cells, located in the exhaust pipe of the engine, and the sensor ECU 5 not shown). The gas sensor 10B has a first electrochemical cell 21B, a second electrochemical cell 31B and the detecting units 22 and 32. The first cell 21B is composed of the electrolyte body 211, the electrodes 212 and 213 and the resistance layer 215. The second cell 313 is composed of the electrolyte body 311, the electrodes 312 and 313, the resistance layer 315 and the catalyst layer 316. The first cell 213 has the first oxygen sensitivity corresponding to the resistance layer 215, while the second cell 313 has the second oxygen sensitivity corresponding to the resistance layer 315.

The gas sensor 10B further has the forming layers 205 and 305, the shielding layers 206 and 306 and the heater layer 401. The first cell 218 is located on the first surface of the heater layer 401, while the second cell 31B is located on the second surface of the heater layer 401 opposite to the first surface. The cells 213 and 313 are symmetrically placed with respect to the heater layer 401.

Therefore, because the cells 21B and 31B are symmetrically placed with respect to the heater layer 401 while using the heater layer 401 together, positions of the cells 213 and 318 in the exhaust pipe are set to be substantially the same as each other, and the cells 213 and 313 are heated by the heater 402 together so as to be set at the same temperature.

Accordingly, in the same manner as the detecting system 1A shown in FIG. 8, the detecting system 13 can precisely detect the hydrogen gas concentration.

Each of the modifications in the first embodiment can be applied for the detecting system 1B.

A gas sensing device may be composed of the detecting system 1B and a gas sensor such as an A/F sensor, a NOx sensor, an oxygen sensor or the like. The sensor ECU 5 shown in FIG. 2 may detect the air-fuel ratio, the NOx concentration or the oxygen concentration in the measured gas from air and fuel detected, in the A/F sensor, NOx detected in the NOx sensor or oxygen detected in the oxygen sensor. Accordingly, the gas sensing device can detect the air-fuel ratio, the NOx concentration or the oxygen concentration in the measured gas while detecting the hydrogen gas concentration in the measured gas with high precision.

### Fourth Embodiment

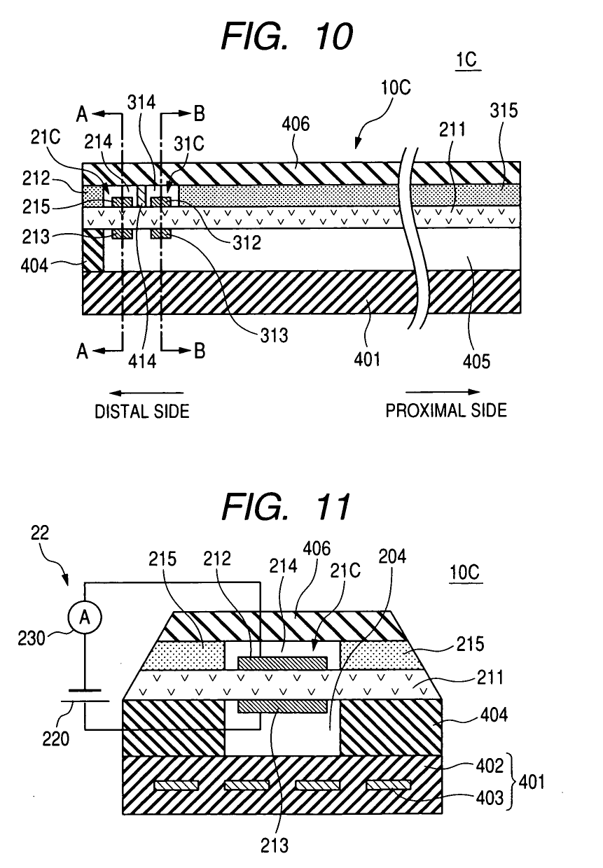

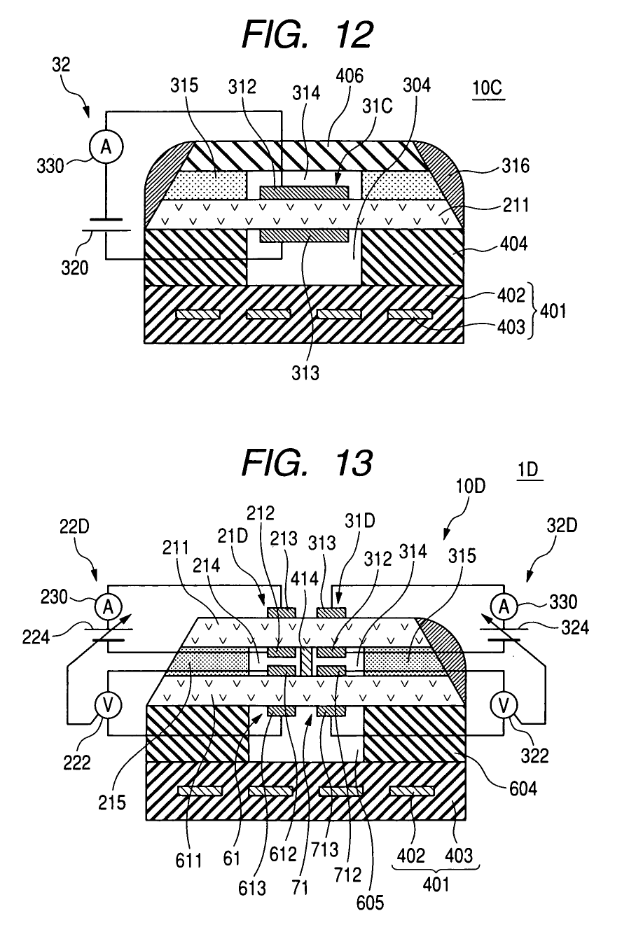

FIG. 10 is a longitudinal sectional view showing a gas sensor of the detecting system according to the fourth embodiment. FIG. 11 is a transverse sectional view taken substantially along line A-A of FIG. 10, while FIG. 12 is a transverse sectional view taken substantially along line B-B of FIG. 10.

As shown in FIG. 10, FIG. 11 and FIG. 12, a hydrogen gas concentration detecting system 1C representing a gas concentration detecting system has a gas sensor 10C with two cells, located in the exhaust pipe of the engine, and the sensor ECU 5 (not shown). The gas sensor 10C has a first electrochemical cell 21C, a second electrochemical cell 31C, and the detecting units 22 and 32. The first cell 21C is composed of the electrolyte body 211, the electrodes 212 and 213, the resistance layer 215 and the partitioning layer 414. The second cell 31C is composed of the electrolyte body 211, the electrodes 312 and 313, the resistance layer 315, the catalyst layer 316 and the partitioning layer 414. The first cell 21C has the first oxygen sensitivity corresponding to the resistance layer 215, while the second cell 31C has the second oxygen sensitivity corresponding to the resistance layer 315. The gas sensor 10C further has the forming layer 404, the shielding layer 406 and the heater layer 401.

The gas sensor 10C differs from the gas sensor 10 shown in FIG. 8 in that the cells 21C and 31C are aligned along the longitudinal direction of the sensor 10C to be placed on the distal side of the sensor 10C. The cells 21C and 31C are placed so as to set the second cell 31C on the proximal side of the first cell 21C. The reference gas is introduced into the chamber 405 from the proximal side of the chamber 204.

Because the cells 21C and 31C are placed to be shifted together toward the distal side, the cells 21C and 31C are placed substantially at the same position in the exhaust pipe. Therefore, the measured gas or the inspection gas exposed to the cell 21C has the same conditions as that of the gas exposed to the cell 31C.

Accordingly, even when the cells 21C and 31C are aligned along the longitudinal direction, the detecting system 1C can precisely detect the hydrogen gas concentration in the measured gas, in the same manner as the detecting system 1A.

Each of the modifications in the first embodiment can be applied for the detecting system 1C.

A gas sensing device may be composed of the detecting system 1C and a gas sensor such as an A/F sensor, a NOx sensor, an oxygen sensor or the like. The sensor ECU 5 shown in FIG. 2 may detect the air-fuel ratio, the NOx concentration or the oxygen concentration in the measured gas from air and fuel detected in the A/F sensor, NOx detected in the NOx sensor or oxygen detected in the oxygen sensor. Accordingly, the gas sensing device can detect the air-fuel ratio, the NOx concentration or the oxygen concentration in the measured gas while detecting the hydrogen gas concentration in the measured gas with high precision.

### Fifth Embodiment

In this embodiment, when cells of a gas sensor are placed in the measured gas, the oxygen gas concentration in each of the gas chambers 214 and 314 is controlled to be set at a constant value.

FIG. 13 is a transverse sectional view showing a gas sensor of the detecting system according to the fifth embodiment. As shown in FIG. 13, a hydrogen gas concentration detecting system 1D representing a gas concentration detecting system has a gas sensor 100 with two cells, located in the exhaust pipe of the engine, and the sensor ECU 5 (not shown).

The gas sensor 10D has the solid electrolyte body 211, the measuring electrodes 212 and 312 located on the first principal plane of the electrolyte body 211, the reference electrodes 213 and 313 located on the second principal plane of the electrolyte body 211 so as to be directly exposed to each of the measured gas and the inspection gas surrounding the sensor 10D, the diffusion resistance layers 215 and 315 located on the first principal plane of the electrolyte body 211, the catalyst layer 316 and the partitioning wall 414.

A first electrochemical cell 21T is composed of the electrodes 212 and 213, the electrolyte body 211 and the resistance layer 215 and the partitioning layer 414. A second electrochemical cell 31D is composed of the electrodes 312 and 313, the electrolyte body 211, the resistance layer 315, the catalyst layer 316 and the partitioning layer 414. The first cell 21D has the first oxygen sensitivity corresponding to the resistance layer 215, while the second cell 31D has the second oxygen sensitivity corresponding to the resistance layer 315.

When the gas sensor 10D is placed in the measured gas, the first cell 21D generates a first output electric current I1 flowing between the electrodes 212 and 213 while increasing or decreasing the oxygen gas existing in the gas chamber 214, and the second cell 31D generates a second output electric current I2 flowing between the electrodes 312 and 313 while increasing or decreasing the oxygen gas existing in the gas chamber 314. Therefore, the oxygen gas concentration in the measured gas introduced into the gas chamber 214 has a dependency on the oxygen gas concentration in the measured gas surrounding the gas sensor 1D, the diffusion resistance of the resistance layer 215 and the first electric current I1. The oxygen gas concentration in the measured gas introduced into the gas chamber 314 has a dependency on the oxygen gas concentration in the measured as surrounding the gas sensor 1D, the diffusion resistance of the layers 315 and 315 and the second output current I2. When the gas sensor 10D is placed in the inspection gas, the first cell 21D generates a first reference electric current Ia flowing between the electrodes 212 and 213, and the second cell 31D generates a second reference electric current Ib flowing between the electrodes 312 and 313.

The gas sensor 10D further has a second solid electrolyte body 611 located so as to place the resistance layers 215 and 315 between the electrolyte bodies 211 and 611, a third measuring electrode 612, a fourth measuring electrode 712, a third reference electrode 613 and a fourth reference electrode 713. The electrodes 612 and 712 are located on the first principal plane of the electrolyte body 611 to be placed in the respective gas chambers 214 and 314. The electrodes 613 and 713 are located on the second principal plane of the electrolyte body 611 so as to be placed in a reference gas chamber 605. The gas chamber 605 is formed to extend along the longitudinal direction of the gas sensor 10D, and the reference gas is introduced into the chamber 605 from the proximal side of the chamber 605 in the longitudinal direction to form an atmosphere of the reference gas in the chamber 605.

A third electrochemical cell 61 is composed of the electrodes 612 and 613, the electrolyte body 611, the resistance layer 215 and the partitioning layer 414. A fourth electrochemical, cell 71 is composed of the electrodes 712 and 713, the electrolyte body 611, the resistance layer 315, the catalyst layer 316 and the partitioning layer 414. When the gas sensor 10D is placed in the measured gas, the third cell 61 generates a first electromotive force (i.e., first voltage) between the electrodes 612 and 613, and the fourth cell 71 generates a second electromotive force (i.e., second voltage) between the electrodes 712 and 713. The first electromotive force has a dependency on the oxygen gas concentration in the measured gas introduced in the gas chamber 214. The second electromotive force has a dependency on the oxygen gas concentration in the measured gas introduced in the gas chamber 314.

The gas sensor 10D further has a first current detecting unit 22D having a voltage detector 222, a changeable battery 224 and the detector 230, and a second current detecting unit 32D having a voltage detector 322, a changeable battery 324 and the detector 330.

The detector 222 detects the first electromotive force of the third cell 61. The detecting unit 22D applies a first electric potential difference to the electrodes 212 and 213 of the first cell 21D while adjusting the first electric potential difference so as to control the first electromotive force at a first constant value, and detects the first output current I1 from the first cell 21D. The detector 322 detects the second electromotive force of the fourth cell 71. The detecting unit 32D applies a second electric potential difference to the electrodes 312 and 313 of the second cell 31D while adjusting the second electric potential difference so as to control the second electromotive force at a second constant value, and detects the second output current I2 from the second cell 31D.

The gas sensor 10D further has a forming layer 604 located on the second principal plane of the electrolyte body 611 so as to surround the reference gas chamber 605, and the heater layer 401 located on the forming layer 604 so as to cover the gas chamber 605 with the heater layer 401 and the forming layer 604.

Because the first electromotive force of the third cell 61 is controlled to a first constant value, the oxygen gas concentration of the measured gas in the gas chamber 214 becomes constant. Further, because the second electromotive force of the fourth cell 71 is controlled, to a second constant value, the oxygen gas concentration of the measured gas in the gas chamber 314 becomes constant.

With this structure of the detecting system 1D, although the oxygen gas concentration of the measured gas surrounding the gas sensor 10D is changeable, the currents I1 and I2 are generated in the cells 21D and 31D while the detecting units 22D and 32D control the oxygen gas concentration of the measured gas in the gas chambers 214 and 314 to constant values. Therefore, as compared with the currents I1 and I2 generated in the detecting systems 1, 1A, 1B and 1C (see FIG. 2, FIG. 8, FIG. 9 and FIG. 10), the currents I1 and 12 in the detecting system 1D are corrected such that the currents I1 and 12 have no dependency on the oxygen gas concentration in the measured gas, and the hydrogen gas output value ΔI determined from the currents I1, I2, Ia, Ib and Ic in the sensor ECU 5 have no dependency on the oxygen gas concentration in the measured gas.

Accordingly, because the detecting system 1D controls the oxygen gas concentration in each of the gas chambers 214 and 314 to a Constant value, the detecting system 1D can determine the hydrogen gas output value ΔI which is reliably independent of the oxygen gas concentration in the measured gas, and the detecting system 1D can further precisely detect the hydrogen gas concentration in the measured gas.

For example, although the hydrogen gas output value ΔI determined in the detecting system 1 shown in FIG. 2 slightly has a dependency on the oxygen gas concentration (see FIG. 5), the hydrogen gas output value ΔI determined in the detecting system 1D can reliably have no dependency on the oxygen gas concentration.

Each of the modifications in the first embodiment can be applied for the detecting system 1D.

A gas sensing device may be composed of the detecting system 1D and a gas sensor such as an A/F sensor, a NOx sensor, an oxygen sensor or the like. The sensor ECU 5 shown in FIG. 2 may detect the air-fuel ratio, the NOx concentration or the oxygen concentration in the measured gas from air and fuel detected in the A/F sensor, NOx detected in the NOx sensor or oxygen detected in the oxygen sensor. Accordingly, the gas sensing device can detect the air-fuel ratio, the NOx concentration or the oxygen concentration in the measured gas while detecting the hydrogen gas concentration in the measured gas with high precision.

These embodiments should not be construed as limiting the present invention to structures of those embodiments, and the structure of this invention may be combined with that based on the prior art.

What is claimed is:

1. A gas concentration detecting system, comprising:
a first cell, having a first sensitivity to oxygen gas, that generates a first output electric current, which has a dependency on the first oxygen sensitivity, concentration of oxygen gas contained in measured gas and concentration of specific gas contained in the measured gas, when the first cell is placed into the measured gas, and generates a first reference electric current, having a dependency on the first oxygen sensitivity, when the first cell is placed into inspection gas containing oxygen gas at a reference concentration;
a second cell, having a second sensitivity to oxygen gas, that generates a second output electric current, having a dependency on the second oxygen sensitivity and concentration of oxygen gas remaining in the measured gag, while removing the specific gas from the measured gas when the second cell is placed into the measured gas, and generates a second reference electric current, having a dependency on the second oxygen sensitivity, when the second cell is placed into the inspection gas;
a reference cell, having a reference sensitivity to oxygen gas, that generates a reference cell electric current, having a dependency on the reference oxygen sensitivity, when the reference cell is placed into the inspection gas; and
a gas concentration detecting unit that determines a first corrected electric current, which has a dependency on the concentration of oxygen gas contained in the measured gas, the concentration of specific gas contained in the measured gas and the reference oxygen sensitivity, from the first output electric current of the first cell, the first reference electric current of the first cell and the reference cell electric current of the reference cell, determines a second corrected electric current, which has a dependency on the concentration of oxygen gas remaining in the measured gas and the reference oxygen sensitivity, from the second output electric current of the second cell, the second reference electric current of the second cell and the reference cell electric current of the reference cell, and detects the concentration of specific gas contained in the measured gas from the first corrected electric current and the second corrected electric current.

2. The system according to claim 1, wherein the gas concentration detecting unit determines a value Ic×I1/Ia of the first corrected electric current by calculating a first product of a value I1 of the first output electric current and a value Ic of the reference cell electric current and dividing the first product by a value Ia of the first reference electric current, and determines a value Ic×I2/Ib of the second corrected electric current by calculating a second product of a value I2 of the second output electric current and the value Ic of the reference cell electric current and dividing the second product by a value Ib of the second reference electric current.

3. The system according to claim 2, wherein the gas concentration detecting unit calculates a value Ic×I2/Ib−Ic×I1/Ia of a specific gas output electric current by subtracting the value of the first corrected electric current from the value of the second corrected electric current and determines the concentration of specific gas contained in the measured gas from the value of the specific gas output electric current.

4. The system according to claim 1, wherein the first corrected electric current determined by the gas concentration detecting unit has no dependency on the first oxygen sensitivity of the first cell, and the second corrected electric current determined by the gas concentration detecting unit has no dependency on the second oxygen sensitivity of the second cell.

5. The system according to claim 1, wherein
the first cell has a first diffusion resistance layer, set at a first diffusion resistance corresponding to the first oxygen sensitivity, through which each of the measured gas and the inspection gas receiving the first diffusion resistance passes, and a pair of first electrodes which induces the oxygen gas, contained in the gas passing through the first diffusion resistance layer, to generate the first output electric current or the first reference electric current between the first electrodes,
the second cell has a catalyst layer which promotes a reaction of the specific gas contained in the measured gas so as to remove the specific gas from the measured gas, a second diffusion resistance layer, set at a second diffusion resistance corresponding to the second oxygen sensitivity, in which each of the measured gas and the inspection gas passing through the catalyst layer receives the second diffusion resistance, and a pair of second electrodes which induces the oxygen gas, contained in the gas passing through the second diffusion resistance layer, to generate the second output electric current or the second reference electric current between the electrodes, and
the reference cell has a reference diffusion resistance layer, set at a reference diffusion resistance corresponding to the reference oxygen sensitivity, through which the inspection gas receiving the reference diffusion resistance passes, and a pair of third electrodes which induces the oxygen gas, contained in the inspection gas passing through the reference diffusion resistance layer, to generate the reference cell electric current between the third electrodes.

6. The system according to claim 1, wherein the gas concentration detecting unit detects the oxygen gas concentration from the first output electric current of the first cell or the second output electric current of the second cell and corrects the detected concentration of specific gas according to the detected oxygen gas concentration.

7. The system according to claim 1, wherein the first and second cells are placed into the inspection gas when an internal combustion engine discontinuously outputting the measured gas outputs no measured gas, and the gas concentration detecting unit measures an electric current generated in the first cell as the first reference electric current, each time the first cell is placed into the inspection gas, to replace the first reference electric current previously measured with the first reference electric current presently measured and to determine the first corrected electric current by using the first reference electric current presently measured, and measures an electric current generated in the second cell as the second reference electric current, each time the second cell is placed into the inspection gas, to replace the second reference electric current previously measured with the second reference electric current presently measured and to determine the second corrected electric current by using the second reference electric current presently measured.

8. The system according to claim 7, wherein the inspection gas is air, and the gas concentration detecting unit measures the first reference electric current, each time the measured gas existing around the first cell is replaced with air after an operation of the internal combustion engine is stopped, and measures the second reference electric current, each time the measured gas existing around the second cell is replaced with air after the operation of the internal combustion engine is stopped.

9. The system according to claim 7, wherein the inspection gas is air, and the gas concentration detecting unit measures the first reference electric current, each time the measured gas existing around the first cell is replaced with air during fuel cut performed in the internal combustion engine, and measures the second reference electric current, each time the measured gas existing around the second cell is replaced with air during the fuel cut performed in the internal combustion engine.

10. The system according to claim 1, wherein the inspection gas is air.

11. The system according to claim 1, wherein a gas sensor having the first and second cells is of a limiting current type, the gas concentration detecting unit measures the first output electric current of the first cell in a first limiting current zone in which the first output electric current has a first constant limiting current value corresponding to the oxygen gas concentration in the measured gas, and the gas concentration detecting unit measures the second output electric current of the second cell in a second limiting current zone in which the second output electric current has a second constant limiting current value corresponding to the oxygen gas concentration in the measured gas.

12. The system according to claim 1, wherein the second cell has a catalyst layer through which the measured gas passes while the specific gas contained in the measured gas is removed, and the catalyst layer is made of at least one of platinum, palladium, rhodium and silver.

13. The system according to claim 1, further comprising:
a third cell that generates a first electromotive force having a dependency on the oxygen gas concentration in the measured gas introduced in a first gas chamber; and
a fourth cell that generates a second electromotive force having a dependency on the oxygen gas concentration in the measured gas introduced in a second gas chamber,
wherein the first cell comprises
a first diffusion resistance layer, set at a first diffusion resistance corresponding to the first oxygen sensitivity of the first cell, through which each of the measured gas and the inspection gas is introduced into the first gas chamber while receiving the first diffusion resistance, the first output electric current of the first cell having a dependency on the oxygen gas concentration and the hydrogen gas concentration in the measured gas introduced in the first gas chamber, the oxygen gas concentration in the measured gas introduced in the first gas chamber being determined from the oxygen gas concentration in the measured gas surrounding the first cell, the first diffusion resistance and the first output electric current of the first cell, and
the second cell comprises
a catalyst layer which promotes a reaction of the specific gas contained in the measured gas so as to remove the specific gas from the measured gas; and
a second diffusion resistance layer, set at a second diffusion resistance corresponding to the second oxygen sensitivity of the second cell, through which each of the measured gas and the inspection gas passing through the catalyst layer is introduced in a second gas chamber while receiving the second diffusion resistance, the second output electric current of the second cell having a dependency on the oxygen gas concentration in the measured gas introduced in the second gas chamber, the oxygen gas concentration in the measured gas introduced in the second gas chamber being determined from the oxygen gas concentration in the measured gas surrounding the second cell, the second diffusion resistance and the second output electric current of the second cell,
and wherein the gas concentration detecting unit applies a first electric potential difference to electrodes of the first cell, such that the first cell generates the first output electric current according to the first electric potential difference, while adjusting the first electric potential difference so as to set the first electromotive force of the third cell at a first constant value, and applies a second electric potential difference to electrodes of the second cell, such that the second cell generates the second output electric current according to the second electric potential difference, while adjusting the second electric potential difference so as to set the second electromotive force of the fourth cell at a second constant value.

14. The system according to claim 1, wherein the first cell comprises
a first solid electrolyte body having oxygen ion conductivity;
a first measuring electrode located on a first surface of the first solid electrolyte body;
a first reference electrode located on a second surface of the first solid electrolyte body; and
a first diffusion resistance layer, located on the first surface of the first solid electrolyte body so as to have a first diffusion resistance corresponding to the first oxygen sensitivity, through which the measured gas or the inspection gas placed around the first cell is introduced into a first measured gas chamber surrounded by the first diffusion resistance layer,
the second cell comprises
a second solid electrolyte body having oxygen ion conductivity;
a second measuring electrode located on a first surface of the second solid electrolyte body;
a second reference electrode located on a second surface of the second solid electrolyte body;
a catalyst layer in which the specific gas contained in the measured gas is reacted with the oxygen gas contained in the measured gas to remove the specific gas from the measured gas; and
a second diffusion resistance layer, located on the first surface of the second solid electrolyte body so as to have a second diffusion resistance corresponding to the second oxygen sensitivity, through which the measured gas, from which the specific gas is removed in the catalyst layer, or the inspection gas is introduced into a second measured gas chamber surrounded by the second diffusion resistance layer so as to be structurally separated from the first measured gas chamber of the first cell,
the reference cell comprises
a third solid electrolyte body having oxygen ion conductivity;
a third measuring electrode located on a first surface of the third solid electrolyte body;
a third reference electrode located on a second surface of the third solid electrolyte body; and
a third diffusion resistance layer, located on the first surface of the third solid electrolyte body so as to have a reference diffusion resistance corresponding to the reference oxygen sensitivity, through which the inspection gas is introduced into a third measured gas chamber surrounded by the third diffusion resistance layer, and
the gas concentration detecting unit comprises
a first current detecting portion that applies a first electric potential difference to the electrodes of the first cell to generate an electric current flowing between the electrodes of the first cell, detects the generated electric current as the first output electric current when the first cell is placed into the measured gas, and detects the generated electric current as the first reference electric current when the first cell is placed into the inspection gas;
a second current detecting portion that applies a second electric potential difference to the electrodes of the second cell to generate an electric current flowing between the electrodes of the second cell, detects the generated electric current as the second output electric current when the second cell is placed into the measured gas, and detects the generated electric current as the second reference electric current when the second cell is placed into the inspection gas; and
a reference cell electric current detecting portion that applies a third electric potential difference to the electrodes of the reference cell to generate an electric current flowing between the electrodes of the reference cell, and detects the generated electric current as the reference cell electric current.

15. The system according to claim 1, wherein the inspection gas contains no specific gas.

16. The system according to claim 1, wherein the specific gas contained in the measured gas is hydrogen gas.

17. The system according to claim 1, wherein the measured gas is exhaust gas, containing hydro carbons, hydrogen gas and oxygen gas, outputted from an internal combustion engine.

18. The system according to claim 1, wherein the specific gas contained in the measured gas is reacted with apart of the oxygen gas contained in the measured gas such that non-reacted oxygen gas remains in the measured gas, the second output electric current has a dependency on the concentration of the non-reacted oxygen gas remaining in the measured gas, and the second corrected electric current has a dependency on the concentration of the non-reacted oxygen gas remaining in the measured gas.

19. A gas sensing device, comprising:
a gas sensor for detecting concentration of particular gas contained in measured gas; and
a gas concentration detecting system, wherein the gas concentration detecting system comprises:
a first cell, having a first sensitivity to oxygen gas, that generates a first output electric current, which has a dependency on the first oxygen sensitivity, concentration of oxygen gas contained in the measured gas and concentration of hydrogen gas contained in the measured gas, when the first cell is placed into the measured gas, and generates a first reference electric current, having a dependency on the first oxygen sensitivity, when the first cell is placed into inspection gas containing oxygen gas at a reference concentration;
a second cell, having a second sensitivity to oxygen gas, that generates a second output electric current, having a dependency on the second oxygen sensitivity and the concentration of oxygen gas remaining in the measured gas, while removing the hydrogen gas from the measured gas when the second cell is placed into the measured gas, and generates a second reference electric current, having a dependency on the second oxygen sensitivity, when the second cell is placed into the inspection gas;
a reference cell, having a reference sensitivity to oxygen gas, that generates a reference cell electric current, having a dependency on the reference oxygen sensitivity, when the reference cell is placed into the inspection gas; and
a gas concentration detecting unit that determines a first corrected electric current, which has a dependency on the concentration of oxygen gas contained in the measured gas, the concentration of hydrogen gas contained in the measured gas and the reference oxygen sensitivity, from the first output electric current of the first cell, the first reference electric current of the first cell and the reference cell electric current of the reference cell, determines a second corrected electric current, which has a dependency on the concentration of oxygen gas remaining in the measured gas and the reference oxygen sensitivity, from the second output electric current of the second cell, the second reference electric current of the second cell and the reference cell electric current of the reference cell, and detects the concentration of hydrogen gas contained in the measured gas from the first corrected electric current and the second corrected electric current.

20. The device according to claim 19, wherein the first corrected electric current has a value Ic×I1/Ia obtained by dividing a first product of a value I1 of the first output electric current and a value Ic of the reference cell electric current by a value Ia is of the first reference electric current, and the second corrected electric current has a value Ic×I2/Ib obtained by dividing a second product of a value X2 of the second output electric current and the value Ic of the reference cell electric current by a value Ib of the second reference electric current.

21. The device according to claim 20, wherein the concentration of hydrogen gas contained in the measured gas is determined from a value Ic×I2/Ib−Ic×I1/Ia of a hydrogen gas output electric current which is obtained by subtracting the value of the first corrected electric current from the value of the second corrected electric current.
